(19) United States
(12) Patent Application Publication
(10) Pub. No.: US 2025/0071670 A1
(43) Pub. Date: Feb. 27, 2025

(54) SLICE-BASED NETWORK SELECTION INFORMATION

(71) Applicant: Lenovo (Singapore) Pte. Ltd., New Tech Park (SG)

(72) Inventors: Genadi Velev, Darmstadt (DE); Apostolis Salkintzis, Athens (GR); Dimitrios Karampatsis, Ruislip (GB)

(21) Appl. No.: 18/723,819

(22) PCT Filed: Feb. 7, 2022
(86) PCT No.: PCT/EP2022/052842

§ 371 Date: Jun. 24, 2024

(30) Foreign Application Priority Data
Dec. 23, 2021 (GR) 20210100911

(51) Int. Cl. H04W 48/18; H04W 8/24

(52) U.S. Cl. CPC H04W 48/18; H04W 8/24

(57) ABSTRACT

Apparatuses, methods, and systems are disclosed for steering a device to networks supporting specific network slices. One method performed by a UE may include transmitting a first message comprising an indication of a UE capability to support slice-based network selection and receiving a second message comprising slice-based network selection information. The method may include storing the received slice-based network selection information and performing slice-based network selection procedure based on the received slice-based network selection information.

### FIELD

The subject matter disclosed herein relates generally to wireless communications and more particularly relates to steering a device to networks supporting specific network slices.

### BACKGROUND

Certain wireless networks support network slicing. A network slice comprises of a set of network functions and corresponding resources (e.g., computing, storage, networking) necessary to provide certain network capabilities and network characteristics. In some embodiments, a network slice is implanted an independent logical network on a physical network infrastructure.

### BRIEF SUMMARY

Disclosed are procedures for steering a device to networks supporting specific network slices. Said procedures may be implemented by apparatus, systems, methods, or computer program products.

One method of a User Equipment (“UE”) for steering a device to networks supporting specific network slices includes sending a first message to the communication network, said first message comprising an indication of a UE capability to support slice-based network selection. The method includes receiving a second message from the communication network, said second message comprising slice-based network selection information. The method includes storing the received slice-based network selection information and performing slice-based network selection procedure according to the received slice-based network selection information.

One method of a User Data Management function (“UDM”) for steering a device to networks supporting specific network slices includes receiving a first message indicating that a UE registers with a second communication network and determining slice-based network selection information for the UE. The method includes provisioning the UE with the slice-based network selection information.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a block diagram illustrating one embodiment of a wireless communication system for steering a device to networks supporting specific network slices;

FIG. 2A is a diagram illustrating one embodiment of a simplified network architecture that supports a mobile device simultaneously using two different network slices;

FIG. 2B is a diagram illustrating one embodiment of a mobile device simultaneously using two different network slices in the home network;

FIG. 2C is a diagram illustrating one embodiment of a mobile device simultaneously using two different network slices via visited network(s);

FIG. 3 is a diagram illustrating one embodiment of UE internal behavior for performing network selection;

FIG. 4A is a diagram illustrating one embodiment of a procedure to provide the UE with slice-based network selection information or information about the simultaneous visited Public Land Mobile Network (“VPLMN”) registration;

FIG. 4B is a continuation of the diagram in FIG. 4A;

FIG. 5 is a diagram illustrating one embodiment of a New Radio (“NR”) protocol stack;

FIG. 6 is a block diagram illustrating one embodiment of a user equipment apparatus that may be used for steering a device to networks supporting specific network slices;

FIG. 7 is a block diagram illustrating one embodiment of a network apparatus that may be used for steering a device to networks supporting specific network slices;

FIG. 8 is a flowchart diagram illustrating one embodiment of a first method for steering a device to networks supporting specific network slices; and

FIG. 9 is a flowchart diagram illustrating one embodiment of a second method for steering a device to networks supporting specific network slices.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for steering a device to networks supporting specific network slices. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

One feature introduced in the 5G communication system (“5GS”) is the support of network slicing. A network slice is an independent (in most cases virtualized) logical network on a physical network infrastructure. In this sense a Network Slice is a logical network that comprises of a set of network functions and corresponding resources (e.g., computing, storage, networking) necessary to provide certain network capabilities and network characteristics. A Network Slice can include the Core Network (i.e., 5G Core network (“5GC”)) control plane and user plane Network Functions (“NFs”) and Access Network (e.g., 5G radio access network or fixed access network).

The UE can be configured with network slice relevant information, which is referred as Network Slice Selection Assistance Information (“NSSAI”). The NSSAI sent to the UE actually comprises several independent information elements (“IE”) called configured NSSAI, allowed NSSAI or rejected NSSAI. Each of the configured NSSAI, allowed NSSAI or rejected NSSAI may consist of one or multiple S-NSSAIs (single Network Slice Selection Assistance information). The network slice is identified in the network and in the UE by an S-NSSAI, i.e., the S-NSSAI is used as network slice identifier.

When a UE is roaming (e.g., located in a foreign country) there may not be a single network which is able to serve all of the subscribed network slices (i.e., list of subscribed S-NSSAIs for the UE). In such case, the UE may use one subset of the subscribed S-NSSAIs in one network (e.g., a first visited Public Land Mobile Network (“VPLMN”) or first Standalone Non-Public Network (“SNPN”)) and another subset of the subscribed S-NSSAIs in another network (e.g., a different VPLMN or SNPN).

In various embodiments, for a roaming UE activating a service/application requiring a network slice not offered by the serving network but available in the area from other network(s), the home Public Land Mobile Network (“HPLMN”) is to be able to provide the UE with prioritization information of the VPLMNs with which the UE may register for the network slice.

Accordingly, the below solutions disclose how to enhance the information available to the UE in roaming scenarios regarding the availability of network slices in VPLMNs available in the roaming country, in order to allow the UE to select and obtain services from the VPLMN supporting the network slices which UE may wish to use.

For UEs that have the ability to obtain service from more than one VPLMN simultaneously, the following requirements may apply. When a roaming UE with a single Public Mobile Land Network (“PLMN”) subscription requires simultaneous access to multiple network slices and the network slices are not available in a single VPLMN, the 5G system shall enable the UE to: A) be registered to more than one VPLMN simultaneously; and B) use network slices from more than one VPLMN simultaneously.

The HPLMN is to be able to authorize a roaming UE with a single PLMN subscription to be registered to more than one VPLMN simultaneously in order to access network slices of those VPLMNs. The HPLMN also is to be able to provide a UE with permission and prioritization information of the VPLMNs the UE is authorized to register to in order to use specific network slices.

Accordingly, the below solutions also disclose how to configure the UE with necessary information to allow and authorize the registration and use of multiple networks (e.g., VPLMNs) simultaneously for different network slices. Said solutions also describe how the UE prioritizes which network to use for which network slice.

According to a first solution, a UE indicates its capability to support slice-based network selection. Consequently, the network (e.g., UDM) determines whether to send to the UE configuration about information for slice-based network selection, i.e., based on the UE capabilities. If the UE is configured with slice-based network selection, then the UE takes into account internally-derived preferred slices when performing network selection, i.e., the UE prioritizes selection of the internally-derived preferred slices.

According to a second solution, a UE indicates its capability to support simultaneous registrations to different networks. Based on the UE capabilities-and based on home network (i.e., HPLMN) policies—the network determines whether to send to the UE authorization information to allow registration with multiple VPLMNs. If authorized to register with multiple VPLMNs, the UE may select an additional VPLMN and start an additional registration.

Note that configuring the UE for slice-based network selection may be implemented independently of configuring the UE with authorization for simultaneous registration with VPLMN. However, the UE may be configured both for slice-based network selection and authorization for simultaneous registration with VPLMN using the same procedure.

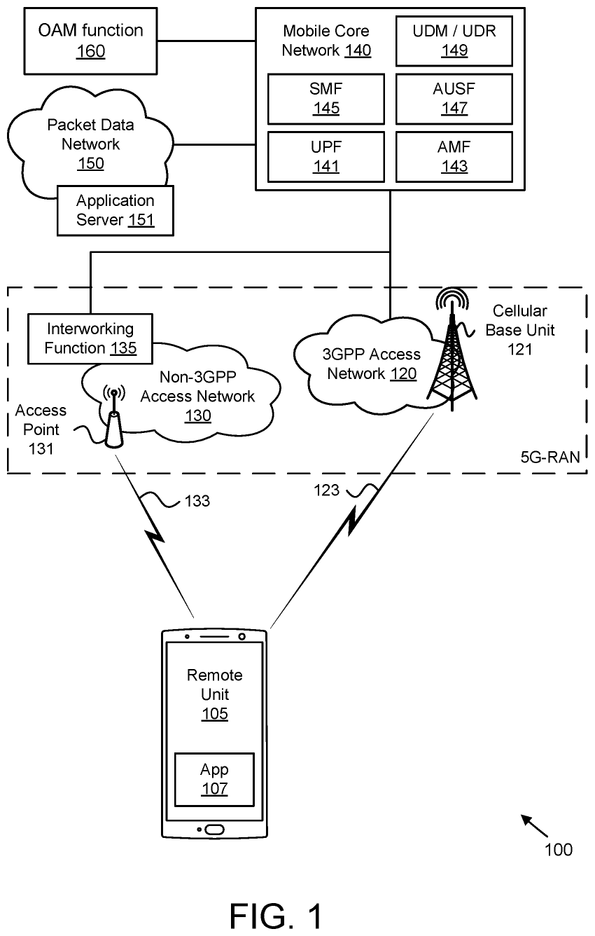

FIG. 1 depicts a wireless communication system 100 for steering a device to networks supporting specific network slices, according to embodiments of the disclosure. In one embodiment, the wireless communication system 100 includes at least one remote unit 105, a 5G Radio Access Network (“5G-RAN”) comprising a Third Generation Partnership Project (“3GPP”) access network 120 and a non-3GPP access network 130, and a mobile core network 140. The 5G-RAN and the mobile core network 140 form a mobile communication network. The 3GPP access network 120 may be composed of a cellular base unit 121 with which the remote unit 105 communicates using wireless communication links 123 and the non-3GPP access network 130 may be composed of an access point 131 with which the remote unit 105 communicates using wireless communication links 133. Even though a specific number of remote units 105, cellular base units 121, wireless communication links 123, access points 131, wireless communication links 133, and mobile core networks 140 are depicted in FIG. 1, one of skill in the art will recognize that any number of remote units 105, cellular base units 121, wireless communication links 123, access points 131, wireless communication links 133, and mobile core networks 140 may be included in the wireless communication system 100.

In one implementation, the 5G-RAN is compliant with the Fifth-Generation (“5G”) cellular system specified in the Third Generation Partnership Project (“3GPP”) specifications. For example, the 3GPP access network 120 may be a Next Generation Radio Access Network (“NG-RAN”), implementing New Radio (“NR”) Radio Access Technology (“RAT”) and/or Long-Term Evolution (“LTE”) RAT. In another implementation, the 5G-RAN is compliant with the LTE system specified in the 3GPP specifications. Moreover, the non-3GPP access network 130 implements a non-3GPP RAT, such as Wi-Fi® or Institute of Electrical and Electronics Engineers (“IEEE”) 802.11-family compliant WLAN. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art.

In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the cellular base units 121 in the 3GPP access network 120 via uplink (“UL”) and downlink (“DL”) communication signals, where the UL and DL communication signals are carried over the wireless communication links 123. Furthermore, the UL communication signals may comprise one or more downlink channels, such as the Physical Uplink Control Channel (“PUCCH”) and/or Physical Uplink Shared Channel (“PUSCH”), while the DL communication signals may comprise one or more downlink channels, such as the Physical Downlink Control Channel (“PDCCH”) and/or

Physical Downlink Shared Channel (“PDSCH”). Here, the 3GPP access network 120 is an intermediate network that provides the remote units 105 with access to the mobile core network 140. Similarly, the remote units 105 may communicate directly with one or more of the access points 131 in the non-3GPP access network 130 via UL and DL communication signals carried over the wireless communication links 133, where the non-3GPP access network 130 is an intermediate network that provides the remote units 105 with access to the mobile core network

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the 5G-RAN. The mobile core network 140 then relays traffic between the remote unit 105 and the application server 151 in the packet data network 150 using the PDU session. The PDU session represents a logical connection between the remote unit 105 and the User Plane Function (“UPF”) 141

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In various embodiments, the remote unit 105 is able to communicate concurrently with both the 3GPP access network 120 and the non-3GPP access network 130. In such embodiments, the remote unit 105 and mobile core network 140 may establish a multi-access connection, such as a Multi Access PDU (“MA PDU”) session, where the multi-access connection comprises a first access path using the 3GPP access network 120 and a second access path in the non-3GPP access network 130. As used herein, an “access path” refers to a user-plane connection using a particular access network and may also be referred to as a “data path” of a multi-access data connection.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QOS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The cellular base units 121 may be distributed over a geographic region. In certain embodiments, a cellular base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The cellular base units 121 are generally part of a RAN, such as the 3GPP access network 120, that may include one or more controllers communicably coupled to one or more corresponding cellular base units 121. These and other elements of radio access network are not illustrated but are well known generally by those having ordinary skill in the art. The cellular base units 121 connect to the mobile core network 140 via the 3GPP access network 120.

The cellular base units 121 may serve a number of remote units 105 within a service area, for example, a cell or a cell sector, via a wireless communication link 123. The cellular base units 121 may communicate directly with one or more of the remote units 105 via communication signals. Generally, the cellular base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the cellular base units 121. Note that during NR operation on unlicensed spectrum (referred to as “NR-U”), the cellular base unit 121 and the remote unit 105 communicate over unlicensed (i.e., shared) radio spectrum.

In various embodiments, one or more non-3GPP access networks 130 are distributed over a geographic region, where each non-3GPP access network 130 serves a number of remote units 105 with a service area (also referred to as a coverage area). An access point 131 in a non-3GPP access network 130 may communicate directly with one or more remote units 105 by receiving UL communication signals and transmitting DL communication signals to serve the remote units 105 in the time, frequency, and/or spatial domain. As noted above, both DL and UL communication signals are carried over the wireless communication links 133. In some embodiments, the wireless communication links 123 and the wireless communication links 133 may employ different frequencies and/or different communication protocols. In various embodiments, an access point 131 may communicate using unlicensed (i.e., shared) radio spectrum.

In some embodiments, a non-3GPP access network 130 connects to the mobile core network 140 via an interworking function 135. The interworking function 135 provides interworking between a non-3GPP access network 130 and the mobile core network 140, e.g., supporting connectivity via the “N2” and “N3” interfaces. Note that both the 3GPP access network 120 and the interworking function 135 communicate with the AMF 143 using a “N2” interface and with the UPF 141 using a “N3” interface.

In certain embodiments, a non-3GPP access network 130 may be controlled by an operator of the mobile core network 140 and may have direct access to the mobile core network 140. Such a non-3GPP deployment is referred to as a “trusted non-3GPP access network.” A non-3GPP access network 130 is considered as “trusted” when it is operated by the 3GPP operator, or a trusted partner, and supports certain security features, such as strong air-interface encryption. While the interworking function 135 is depicted as being located outside both the non-3GPP access network 130 and the mobile core network 140, in other embodiments the interworking function 135 may be co-located with the non-3GPP access network 130 (e.g., if the non-3GPP access network 130 is a trusted non-3GPP access network) or located within the mobile core network 140.

In one embodiment, the mobile core network 140 is a 5G Core network (“5GC”) or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access 30 and Mobility Management Function (“AMF”) 143 that serves the 5G-RAN, a Session Management Function (“SMF”) 145, an Authentication Server Function (“AUSF”) 147, a Unified Data Management function (“UDM”) and a User Data Repository (“UDR”). In some embodiments, the UDM is co-located with the UDR, depicted as combined entity “UDM/UDR” 149. Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (“DN”), in the 5G architecture. The AMF 143 is responsible for termination of Non-Access Spectrum (“NAS”) signaling, NAS ciphering & integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation & management, DL data notification, and traffic steering configuration of the UPF 141 for proper traffic routing.

The AUSF 147 may act as an authentication server and/or authentication proxy, thereby allowing the AMF 143 to authenticate a remote unit 105. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like.

In various embodiments, the mobile core network 140 may also include additional NFs, such as a Policy Control Function (“PCF”) (e.g., responsible for unified policy framework, providing policy rules to CP functions, access subscription information for policy decisions in UDR), a Network Repository Function (“NRF”) (e.g., which provides Network Function (“NF”) service registration and discovery, enabling NFs to identify appropriate services in one another and communicate with each other over Application Programming Interfaces (“APIs”)), a Network Exposure Function (“NEF”) (e.g., which is responsible for making network data and resources easily accessible to customers and network partners), or other NFs defined for the 5GC. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. A “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

The wireless communication system 100 includes an operations, administration, and management (“OAM”) function 160. In various embodiments, the OAM function 160 performs slice instantiation, e.g., in response to a request from a service provider. The OAM function 160 may provide network slice configuration parameters to the mobile core network 140 (e.g., to the UDM/UDR 149) indicating which network slices are available in other (e.g., visited) networks. Note that an OAM function 160 may receive parameters and/or configurations from a Business Support System (“BSS”) and/or an Operations Support System (“OSS”).

As mentioned previously, when a remote unit 105 is roaming (e.g., located in a foreign territory) there may not be a single network which is able to serve all of the subscribed network slices (i.e., list of subscribed S-NSSAIs for the UE). In such case, the remote unit 105 may use one subset of the subscribed S-NSSAIs in one network (e.g., a first visited Public Land Mobile Network (“VPLMN”) or first Standalone Non-Public Network (“SNPN”)) and another subset of the subscribed S-NSSAIs in another network (e.g., a different VPLMN or SNPN).

According to embodiments of the first solution, the remote units 105 may support new capabilities (e.g., new UE parameter update (“UPU”) data types) to receive, store and use slice-based network selection information. In some embodiments, the remote units 105 sends the new capabilities to the mobile core network 140 (where the UDM/UDR 149 is the final destination of the new capabilities information) and receives the slice-based network selection information in response. The remote units 105 may also apply slice-based network selection information for network selection procedure (i.e., in case that the none of the available networks support all subscribed S-NSSAIs).

According to embodiments of the second solution, the remote units 105 may support new capabilities (e.g., new UPU data types) to receive, store and use authorization for simultaneous network registrations. In some embodiments, the remote units 105 sends the new capabilities to the mobile core network 140 (where the UDM/UDR 149 is the final destination of the new capabilities information) and receives the authorization for simultaneous network registrations in response. The remote units 105 may also perform simultaneous registrations with different networks (i.e., in case that the none of the available networks support all subscribed S-NSSAIs).

According to embodiments of the first solution, the UDM/UDR 149 may support procedures to retrieve (or receive) and store new UE capabilities (e.g., indicating that a remote unit 105 supports new UPU data types) associated with slice-based network selection information. In some embodiments, the UDM/UDR 149 may create and send configuration information to the remote unit 105 for slice-based network selection information.

According to embodiments of the second solution, the UDM/UDR 149 may support procedures to retrieve (or receive) and store new UE capabilities (e.g., indicating that a remote unit 105 supports new UPU data types) associated with authorization for simultaneous network registrations. In some embodiments, the UDM/UDR 149 may create and send configuration information to the remote unit 105 for authorization for simultaneous network registrations.

While FIG. 1 depicts components of a 5G RAN and a 5G core network, the described embodiments for steering a device to networks supporting specific network slices apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA 2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “gNB” is used for the base station/base unit, but it is replaceable by any other radio access node, e.g., RAN node, ng-eNB, eNB, Base Station (“BS”), Access Point (“AP”), etc. Additionally, the term “UE” is used for the mobile station/remote unit, but it is replaceable by any other remote device, e.g., remote unit, MS, ME, etc. Further, the operations are described mainly in the context of 5G NR. However, the below described solutions/methods are also equally applicable to other mobile communication systems for steering a device to networks supporting specific network slices.

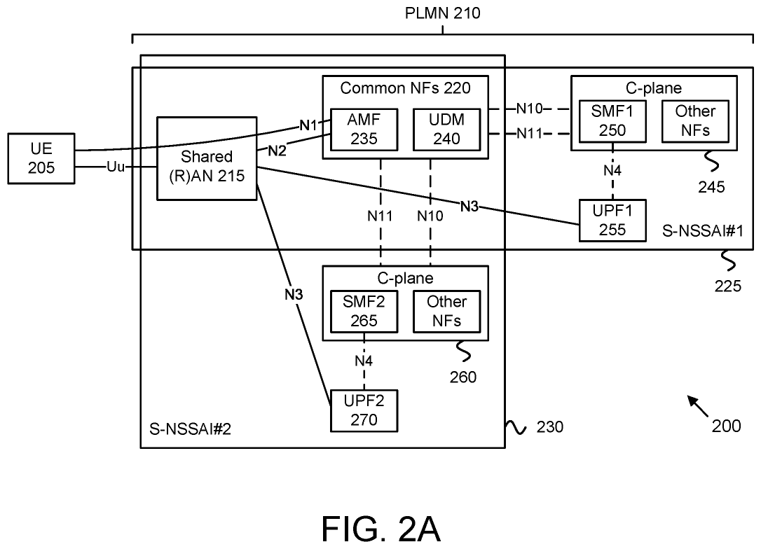

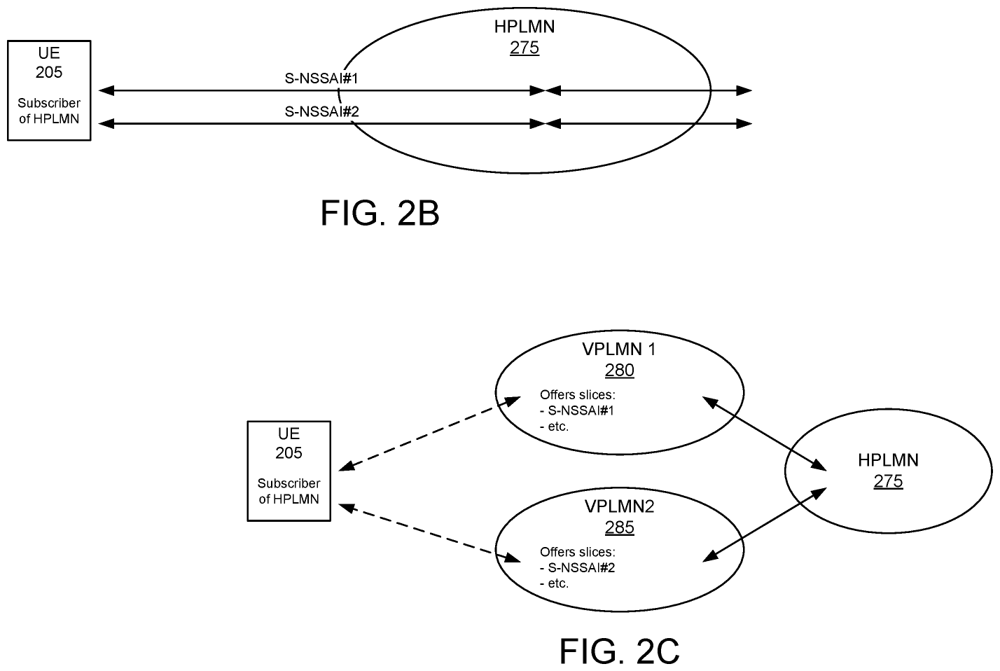

FIG. 2A depicts a simplified 5GS architecture 200 where a UE 205 uses two different network slices in a PLMN 210, according to embodiments of the disclosure. In the depicted embodiment, the PLMN 210 includes a (R) AN 215 shared among various core NFs and network slices (denoted “shared (R) AN”), a set of common network functions 220, and a plurality of network slices, including a first network slice 225 (having identifier “S-NSSAI #1) and a second network slice 230 (having identifier “S-NSSAI #2”). The set of common network functions 220 includes at least an AMF 235 and a UDM 240. In certain embodiments, the set of common network functions 220 may include other NFs, such as Network Slice Selection Function (“NSSF”), PCF, or other control plane (“C-plane”) NFs.

As depicted each network slice includes a set of control plane functions. The set of control plane functions 245 in the first network slice 225 includes a first SMF (denoted “SMF1”) 250 among other control plane NFs. The first network slice 225 also includes a first UPF (denoted “UPF1”) 255. The set of control plane functions 260 in the second network slice 230 includes a second SMF (denoted “SMF2”) 265 among other control plane NFs. The second network slice 230 also includes a second UPF (denoted “UPF2”) 270.

The UE 205 may be one embodiment of the remote unit 105. The shared (R) AN 215 may be one embodiment of the NG-RAN (i.e., 3GPP access network 120 and/or non-3GPP access network 130). The AMF 235 may be one embodiment of the AMF 143. The UDM 240 may be one embodiment of the UDM/UDR 149. The first SMF 250 and second SMF 265 may be embodiments of the SMF 145. The first UPF 255 and second UPF 270 may be embodiments of the UPF 141.

The UE 205 communicates with the shared (R)AN 215 via the Uu interface. The UE 205 and communicates with the AMF 235 via an N1 interface. The shared (R)AN 215 communicates with the AMF 235 via an N2 interface. The shared (R)AN 215 communicates with the UPFs 255/270 via an N3 interface. The SMFs 250/265 communicate with the UPFs 255/270 via an N4 interface. The SMFs 250/265 communicate with the UDM 240 via an N10 interface. The AMF 235 communicates with the SMFs 250/265 via an N11 interface.

FIG. 1 shows example 5GS architecture for a UE associated with two network slices-“S-NSSAI #1” depicted in grey line and “S-NSSAI #2” depicted in dotted black line. According to this example architecture the (R) AN part of the two network slices is shared. The core network (CN) part has a Common Network Functions (CNFs) and dedicated CN Network Functions like [SMF1, UPF1, and other NFs] belonging to S-NSSAI #1 and [SMF2, UPF2 and other NFs] belonging to S-NSSAI #2.

Please note that FIG. 2A does not include all NFs and all reference points. Rather, the simplified 5GS architecture 200 depicts a subset of the NFs and reference points/interfaces supported in 5GC. Additional information about the functionality of the NFs (e.g., AMF, NSSF, SMF, UPF, etc.), the reference points and the 5GS is described in 3GPP Technical Specification (“TS”) 22.261 (v18.4.0) and 3GPP TS 23.501 (v17.2.0).

FIG. 2B depicts an exemplary non-roaming scenario of the UE 205 using two different network slices simultaneously, according to embodiments of the disclosure. When the UE 205 is registered with its home network, i.e., HPLMN 275, the UE 205 may use network slices S-NSSAI #1 and S-NSSAI #2 simultaneously.

FIG. 2C depicts an exemplary roaming scenario of the UE 205 using two different network slices simultaneously, according to embodiments of the disclosure. When the UE is roaming, there may not be a single VPLMN which can serve both network slices S-NSSAI #1 and S-NSSAI #2.

According to a first solution, the UE 205 indicates to the HPLMN 275 the UE's capability to support slice-based network selection. Consequently, the HPLMN 275 (e.g., the UDM 240 in HPLMN) determines whether to configure the UE 205 with information for slice-based network selection, i.e., based on the UE capabilities.

According to a second solution, a UE indicates its capability to support simultaneous registrations to different networks. Based on the UE capabilities-and based on home network (i.e., HPLMN) policies—the network determines whether to send to the UE authorization information to allow registration with multiple VPLMNs.

Note that configuring the UE 205 for slice—based network selection may be implemented independently of configuring the UE 205 with authorization for simultaneous registration with multiple VPLMNs. However, the UE 205 may be configured both for slice-based network selection and authorization for simultaneous registration with multiple VPLMNs using the same procedure.

If the UE 205 is configured with slice-based network selection, then the UE takes into account internally-derived preferred slices when performing network selection, i.e., the UE prioritizes selection of the internally-derived preferred slices. If the UE 205 is authorized to register with multiple VPLMNs, then the UE 205 may select an additional VPLMN and start an additional registration.

Consequently, the UE 205 may use the S-NSSAI #1 in a first VPLMN (depicted “VPLMN1”) 280 while concurrently using the S-NSSAI #2 in a second VPLMN (depicted “VPLMN2”) 285. As depicted, the UE 205 establishes a connection to the HPLMN 275 via the first VPLMN 280 for using the S-NSSAI #1 and establishes another connection to the HPLMN 275 via the second VPLMN 285 for using the S-NSSAI #2.

The solutions disclosed herein target how to configure the UE with necessary information to allow and authorize (1) to select and obtain services from the networks (VPLMN, SNPN) supporting the network slices which UE may wish to use and (2) to register with and use of multiple networks (e.g., VPLMNs, SNPNs) simultaneously for different network slices. Note that the solutions 1 and 2 are independent from each other. Moreover, common procedures are described to implement both solutions.

According to the common procedure, the UE may provide to the network (e.g., to the UDM) capabilities for at least one of:
slice-based network selection support (e.g., a network selection which considers the network slices, which the UE wishes to use, and the network slices supported in the candidate scanned PLMNs/SNPNs. The information configured in the UE comprises mapping of network slice(s) to network ID); and/or
simultaneous VPLMN registration support (e.g., SimulPLMNsReg).

The UDM determines whether to configure the UE with information about (1) how to select networks supporting a subset of the UE's subscribed slices and/or (2) use simultaneous registrations to multiple networks (e.g., VPLMNs). The UDM can make the determination based on at least one of:
capability of the UE to support 1) slice-based network selection information or 2) or registration with multiple networks;
configuration information in the UDM/UDR that specific slices are available in specific networks; and/or.
the network ID of the currently selected (visited) network.

The UDM provides the UE with the following configuration information: (1) slice-based network selection information (mapping of slice to a VPLMN/SNPN in priority order) and (2) authorization and configuration data for simultaneous VPLMN registration.

If there are no available networks which supports all UE's subscribed S-NSSAI(s), the UE determines preferred S-NSSAI(s) and performs network selection based on the preferred S-NSSAI(s) and the slice-based network selection information.

The slice-based network selection mechanism relies on slice-based network selection information (e.g., as part of more common “slice-based network selection configuration”), created in the home network (e.g., HPLMN, SNPN or credential holder (“CH”)) and provided to the UE. This information may be provided as:
1) a part of the existing information, e.g., the “Operator controlled PLMN selector with Access Technology” list which may be enhanced to include the mapping of network slice to a network ID (e.g., VPLMN/SNPN) in priority order; or
2) a newly introduced parameter/information, e.g., called “operator-controlled slice based network selector with access technology” list which includes the mapping of network slice to a network ID (e.g., VPLMN/SNPN) in priority order. For example, this can be a new UPU data type.

In any of the cases 1) or 2), the UE uses the slice-based network selection information when the available networks support a sub-set of the UE's subscribed S-NSSAIs. When the UE determines such situation, the UE should (internally) determine preferred S-NSSAI(s) and should apply the slice-based network selection information in order to select a suitable network.

The slice-based network selection information comprises mapping of network slice(s) to a network ID(s), e.g., VPLMN/SNPN IDs, in priority order. The following examples illustrate possible contents of the mapping information.

Example #1: the mapping of network slice ID to a network ID and associated priority (or priority order) is shown in Table 1, below:

TABLE 1
Mapping of Network Slice ID to Network ID

| Network Slice ID | Network ID + Associated Priority |
|---|---|
| S-NSSAI#1 & | list of PLMNs/SNPNs (e.g., PLMN1) in |
| S-NSSAI#2 | priority order (e.g., can be the same as the |
| | “Operator controlled PLMN selector with |
| | Access Technology” list). |
| | This entry may be optional as the list of |
| | PLMNs/SNPNs may be the same as the |
| | “Operator controlled PLMN selector with |
| | Access Technology” list. |
| S-NSSAI#1 | [PLMN2, prio2], [PLMN4, prio3] |
| S-NSSAI#2 | [PLMN3, prio2] |

Example #2: the mapping of network ID to network slice ID and associated priority (or priority order) is shown in Table 2, below:

TABLE 2
Mapping of Network ID to Network Slice ID

| | Network Slice ID + |
|---|---|
| Network ID | Associated Priority |
| [any PLMN ID except the | [S-NSSAI#1, S-NSSAI#2] |
| ones listed below] | (this entry is optional) |
| (this entry is optional) | |
| PLMN1 | S-NSSAI#1, S-NSSAI#2, prio1 |
| PLMN2 | S-NSSAI#1, prio2 |
| PLMN4 | S-NSSAI#1, prio3 |
| PLMN3 | S-NSSAI#2, prio2 |

In the Table 1, the first row shows a list of PLMNs/SNPNs (e.g., PLMN1) supporting all UEs network slices (e.g., both S-NSSAI #1 and S-NSSAI #2), so that the UE should first try to select these networks. Please note that this list may be the same (and thus the first row is optional and may be omitted in the slice-based network selection information)-in other words the slice-based network selection information may exclude the first row depicted in Table 1.

According to the Example #1, the UE may apply the following processing:
1) If none of the networks from the first row of Table 1 are available in the current UE location, the UE should attempt to select a network depending on the service (i.e., the most important service) associated with a particular network slice (e.g., S-NSSAI #1 or S-NSSAI #2) which the UE wishes to use. Such network slice(s) are denoted as “preferred S-NSSAI(s)”.
2) After the UE has identified the preferred S-NSSAI(s), the UE selects a network to register using the remaining rows of Table 1. For example, if the preferred network slice is S-NSSAI #1, the UE selects PLMN2 or PLMN4, which are associated with corresponding priority for network selection (e.g., prio2 and prio3 whereas prio3 means the lowest priority). If the preferred network slice is S-NSSAI #2, the UE selects PLMN3 (assuming that PLMN1 is not available).

In the Table 2, the opposite mapping is shown, i.e., each network ID is mapped to the supported slices. Again, the UE first attempts to select a network which supports all configured/subscribed S-NSSAIs in the UE, i.e., the UE tries to select PLMN1. If such network (e.g., PLMN1) is not available, the UE identifies which is the preferred network slice as described above.

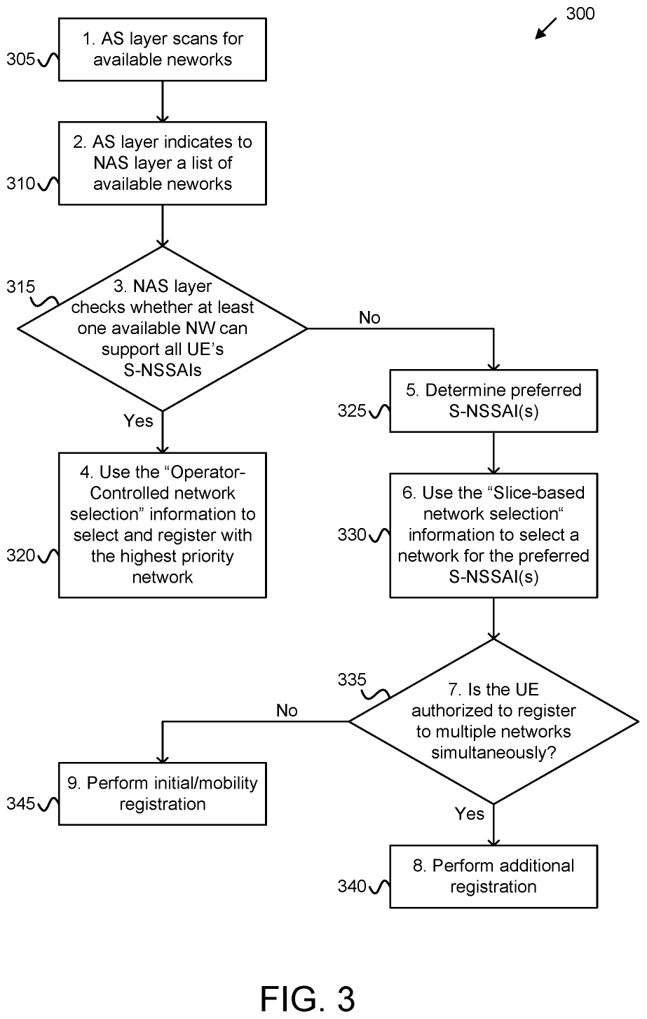

FIG. 3 depicts exemplary UE internal behavior for a procedure 300 of how to perform network selection using the new “slice-based network selection information” and the “Operator controlled PLMN selector with Access Technology” information. The procedure 300 may be implemented by the UE 205 when performing network selection.

In step 1 the Access Stratum (“AS”) layer scans and measures for available networks (see activity block 305).

In step 2, the AS layer informs the Non-Access Stratum (“NAS”) layer about the list of available networks (see activity block 310).

In step 3, the UE (e.g., NAS layer) performs a check whether at least one available network (“NW”) can support all UE's subscribed/configured S-NSSAIs (see decision block 315). The following options apply:

If yes (i.e., step 4) where there are one or more networks supporting all of the UEs subscribed S-NSSAIs), the UE applies the “Operator controlled PLMN selector with Access Technology” list to select an appropriate network and start registration procedure (see activity block 320).

In no (i.e., step 5), where all available networks support only a subset of the UE's subscribed/configured S-NSSAIs), the UE determines the preferred (or desired) S-NSSAI(s) in the current moment, e.g., based on the connectivity request from upper layer (e.g., service/application(s)), or based on the default service/application(s) (see activity block 325).

The UE may determine the preferred S-NSSAI by taking the UE route selection policy (“URSP”) rules in consideration, e.g., the UE determines the preferred service or application and derives the corresponding S-NSSAI(s) from the URSP rule. These S-NSSAI(s) form the preferred S-NSSAI.

In step 6), the UE uses the slice-based network selection information to determine which available networks support the preferred S-NSSAI(s), e.g., according to the mapping of network slice to a network ID in Example #1, above (see activity block 330).

In step 7), the UE evaluates whether the UE is authorized to register to multiple NWs simultaneously (see decision block 335). The following options apply:

If yes (i.e., step 8), the UE selects the network ID with the highest priority from the mapping of network slice to a network ID supporting this preferred S-NSSAI(s) and indicates to the AS layer the selected network ID (e.g., during the registration procedure). The UE initiates registration procedure with the selected NW by using additional registration type (see activity block 340). In other words, the UE selects a new network and uses simultaneously the old network to the new network, whereas the UE registers with different network slices to the old and new networks.

In no (i.e., step 9), the UE selects the network ID with the highest priority similar to step 8. The UE initiates registration procedure with the selected NW by using either initial or mobility registration type (see activity block 345). In other words, the UE re-selects a new network and switches from the old to the new network.

Note that the UE re-evaluates the preferred S-NSSAI(s) based on request from the upper layer. For example, if the UE determines that a new preferred S-NSSAI(s) applies, then the UE may perform a network selection procedure either from step 1) or from step 6). This may result in selecting a network (serving the new preferred S-NSSAIs) different from the currently selected or registered network.

According to 3GPP Release 16, the UE is not configured with a list of subscribed S-NSSAIs. Therefore, the UE must derive the list of subscribed S-NSSAIs, which information is typically exclusive to the core network. In one embodiment, the UE may derive its subscribed S-NSSAIs using the slice-based network selection information. Here, the UE may extract all S-NSSAIs for which there is mapping information. In another embodiment, the UE may derive its subscribed S-NSSAIs using the URSP rules stored in the UE. Here, the UE may extract all S-NSSAIs from the Route Selection Descriptor (“RSD”) part of the URSP rules. Note that each URSP rule contains a Traffic Descriptor (i.e., containing one or more attributes that determines when the rule is applicable) and a set of one or more RSDs that indicate how traffic matching the Traffic Descriptor is to be routed. The parameters of an RSD may include one or more of: a Session and Service Continuity (“SSC”) Mode, a network slice selection (i.e., one or more S-NSSAIs), a Data Network Name (“DNN”), a PDU Session Type Selection, an Access Type Preference, and/or another parameter specified in 3GPP TS 23.503 (v17.2.0).

In other embodiments, the UE may derive its subscribed S-NSSAIs using the configured NSSAI for the HPLMN, if available. The UE may determine the HPLMN ID based on the stored SUPI, which includes the MCC and MNC of the HPLMN. Then the UE can identify the stored configured NSSAI for the HPLMN and extract the S-NSSAI values from the configured NSSAI.

Alternatively, the UE may be provided with the subscribed NSSAI parameter containing a list of Subscribed S-NSSAIs as stored in the UDR/UDM. For example, the UDM may send the subscribed NSSAI to the UE using the UPU procedure, where the subscribed NSSAI may be defined as a new UP data type.

Note that all S-NSSAI values from the above examples are S-NSSAI values used in the HPLMN (i.e., the values stored in the subscribed S-NSSAIs list in the UDM/UDR in the home network). In other words, (1) the preferred S-NSSAI(s) and (2) the S-NSSAIs in the slice-based network selection information comprise the HPLMN values of the S-NSSAIs. After the network selection is performed and the UE stores configured NSSAI for the selected network, the UE should use the S-NSSAI values from the configured NSSAI.

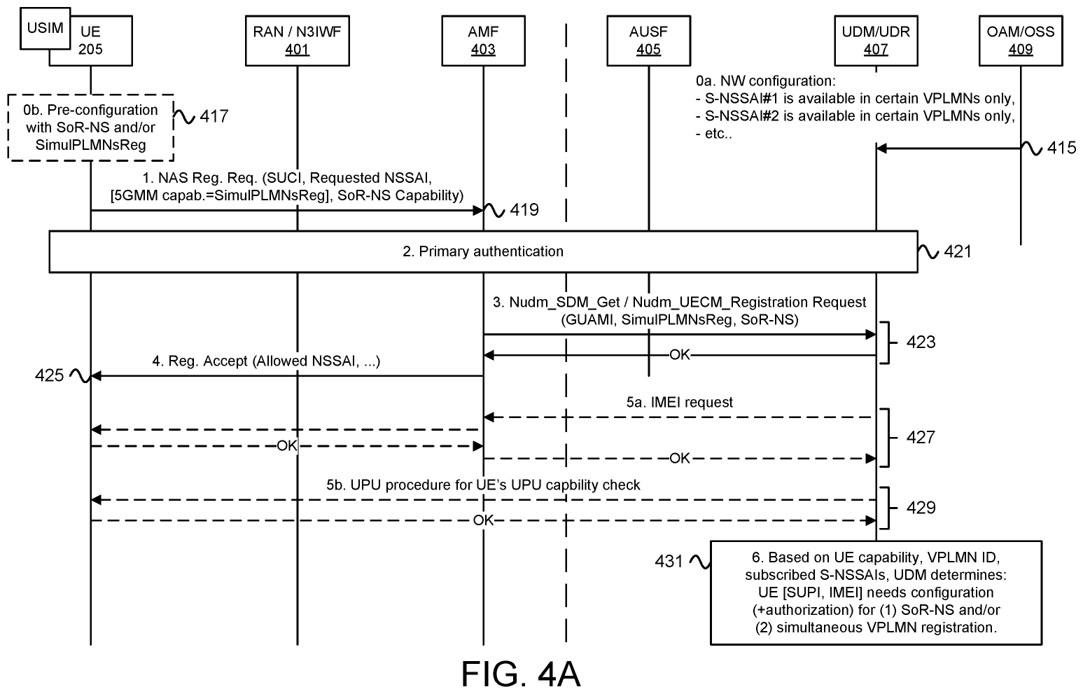

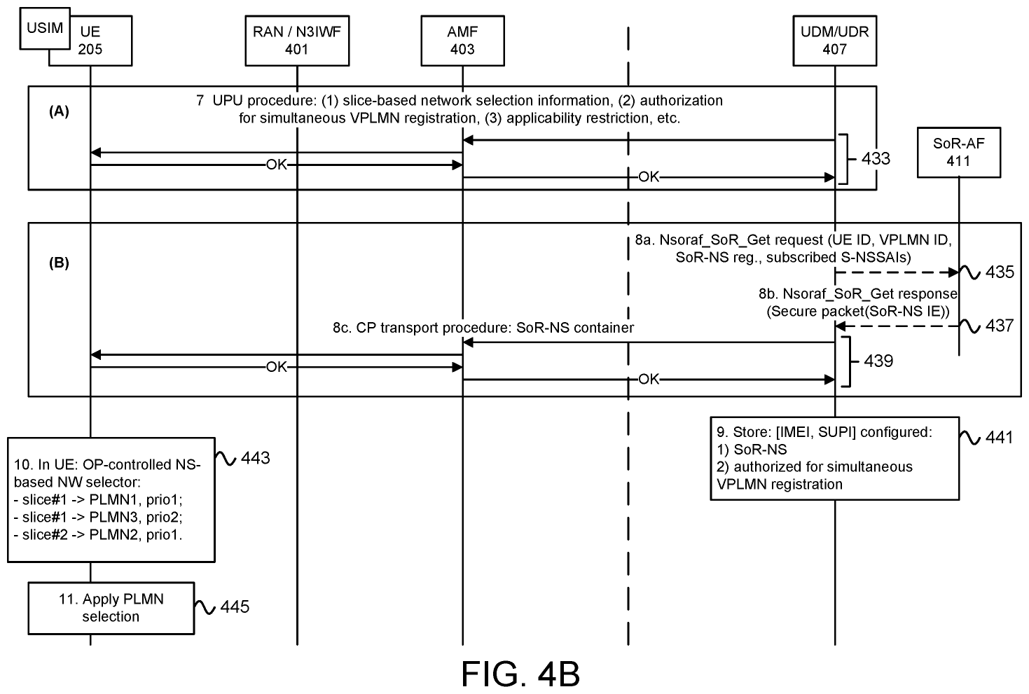

FIGS. 4A-4B depicts exemplary call-flow for a UE configuration procedure 400 to provide the UE with slice-based network selection information or information about the simultaneous VPLMN registration, according to embodiments of the disclosure. The procedure 400 involves the UE 205 comprising a USIM, a RAN 401 (optionally containing a N3IWF), an AMF 403, and AUSF 405, a UDM/UDR 407, an OAM or operations support systems (depicted as combined element “OAM/OSS” 409), and a steering of roaming application function (“SoR-AF”) 411. It is assumed that the UE 205 is subscribed for S-NSSAI #1 and S-NSSAI #2.

The RAN 401 may be one embodiment of the NG-RAN, i.e., comprising a 3GPP access network 120 and/or a non-3GPP access network 130. Where the RAN 301 comprises a non-3GPP access network 130, communications between the UE 205 and AMF 403 may pass through a Non-3GPP Interworking Function (“N3IWF”). The AMF 403 may be an embodiment of the AMF 235 and/or AMF 143. The AUSF 405 may be one embodiment of the AUSF 147. The UDM/UDR 407 may be one embodiment of the UDM 240 and/or UDM/UDR 149. The OAM/OSS 409 may be one embodiment of the OAM function 160.

Note that the AUSF 405 and the UDM/UDR 407 are network functions in the HPLMN of the UE 205. In certain embodiments, the RAN/N3IWF 401 and serving AMF 403 also belong to the to the HPLMN. In other embodiments, the UE 205 is roaming and the RAN/N3IWF 401 and AMF 403 belong to a VPLMN. The detailed description of the procedure 400 is as follows:

At Step 0a, the network (e.g., UDM or UDR in the HPLMN's 5GC) is configured that one or more network slices (identified by S-NSSAI) are available in specific visited networks 30) (VPLMNs) (see messaging 415). For example, the UDM/UDR 407 may be configured via the OAM or operations support systems (depicted as combined element “OAM/OSS” 409). In other words, some S-NSSAIs are available in some visited networks, whereas other S-NSSAIs are available in another visited networks. For example, S-NSSAI #1 is available in certain VPLMNs/SNPNs only, and S-NSSAI #2 is available in certain other VPLMNs/SNPNs. In certain embodiments, the OSS can dispose this information to the operations, administration, and management (“OAM”), which can configure the corresponding network functions (e.g., UDM/UDR 149) in the HPLMN.

At Step 0b, the UE 205 may be pre-configured with one or more of the following information: (1) slice-based network selection information (e.g., Operator Controlled Slice based NW selector) or (2) authorization for simultaneous VPLMN registration (see messaging 417). This may be referred as “slice-based network selection configuration” and can be associated with a configuration version identifier ID.

At Step 1, the UE 205 performs a registration procedure with the network (e.g., VPLMN or HPLMN) by sending a registration request message (see messaging 419). During the (initial) registration procedure, especially when the association in the UE 205 between the SUPI and the International Mobile Equipment Identity (“IMEI”) has changed or the UE 205 registers with a PLMN in a region (e.g., country) different from the region of the previous registration, the UE 205 may include one or more indications about the capability of supporting slice-based network selection information (e.g., Network-Slice based Steering of Roaming, denoted “SoR-NS”) or authorization for simultaneous VPLMN registrations (e.g., denoted “SimulPLMNsReg”).

For example, the UE 205 may provide the SoR-NS and/or SimulPLMNsReg capabilities as part of the 5GS Mobility Management (“5GMM”) capability sent to the AMF 403; or as independent Information Element (“IE”) in the full Registration Request message (e.g., as supported UE parameters update data types, i.e., supported UPU data types). The latter case may be meant as parameter(s) to be sent to the UDM/UDR 407, i.e., the AMF 403 only relays this parameter to the UDM.

The UE 205 may determine this SimulPLMNsReg capability based on the capability of dual radio or specific NAS layer implementation possible to use the USIM/ME credentials for different registrations. The SoR-NS capability can be an ME or USIM capability. The ME part of the UE 205 may need to support new UPU data set types.

Alternatively, the capability of the UE 205 to support the SoR-NS capability and/or SimulPLMNsReg capability may be sent to the UDM/UDR 407 in the acknowledgment message after receiving the UPU update request, in step 7 or 8 on FIG. 4B. In other words, the UE 205 sends a response message to the UDM/UDR 407 indicating whether the new parameters (e.g., slice-based network selection information or authorization for simultaneous VPLMN registrations) are successfully verified and stored in the UE 205. The indications of success or failure in the acknowledgment/response message to the UDM/UDR 407 may implicitly indicate the UE capability. Further details are described in step 10.

If the UE 205 stores pre-configuration information as per step 0b, the UE 205 may indicate the version ID of the configuration. The configuration version ID is meant to be used at the UDM/UDR 407 or in the SoR-AF. In this sense, the AMF 403 relays this information to the UDM in step 3. Please also see step 7.

At Step 2, the AMF 403 triggers primary authentication, if needed (i.e., there is no valid UE security context in the AMF 403), where the AUSF 405 and the UDM/UDR 407 (or optionally a AAA-server in case of credential holder “CH”) are included in the authentication procedure (see block 421).

At Step 3, if the UE 205 has indicated one or more (UPU data type) capabilities (e.g., support of SoR-NS, SimulPLMNsReg or configuration version ID) in step 1, then the AMF 403 forwards the received UPU data indication to the UDM/UDR 407 (see messaging 423). For example, the AMF 403 may send to the UDM/UDR 407 the capability parameters SoR-NS and/or SimulPLMNsReg (or configuration version ID) in the service operation Nudm_UECM_Registration request message or in Nudm_SDM_Get request message. Note that the Nudm_UECM_Registration/Nudm_SDM_Get request message contains a Globally Unique AMF ID (“GUAMI”) of the AMF 403 and the UE subscription ID (e.g., SUPI).

At Step 4, the network (e.g., AMF 403) may complete the registration procedure by sending a Registration accept message to the UE 205 (see messaging 425).

At Step 5a, after receiving the UE's (UPU data) capability of SOR-NS, SimulPLMNsReg or configuration version ID, and if at some of the UE's subscribed S-NSSAIs are served by specific VPLMNs (see step 0a), the UDM/UDR 407 may determine to retrieve to the UE's IMEI in order to verify whether the UE 205, i.e., combination of SUPI and IMEI, has been already configured for slice-based network selection information or authorization for simultaneous VPLMN registration.

For this purpose, the UDM/UDR 407 may send a request to the AMF to send the IMEI associated with the SUPI (see messaging 427). Note that the SUPI is used as a key ID in the signaling between AMF 403 and UDM/UDR 407. If the AMF 403 does not store the IMEI in the UE context, the AMF 403 may perform an identity request procedure with the UE 205 over the NAS protocol. The AMF 403 sends a reply to the UDM/UDR 407 with the UE's IMEI. The UDM/UDR 407 may store the UE's UPU data types capabilities in the UE's context in the UDM/UDR 407 for this IMEI.

At Step 5b, if the UDM/UDR 407 has not received UE's UPU capabilities in step 3, the UDM/UDR 407 (based on local policy) may determine to initiate UPU procedure for UE's UPU capability check (see messaging 429). In this scenario, the UDM/UDR 407 does not send configuration information to be provisioned in the UE 205, but UDM/UDR 407 first performs the UPU procedure to retrieve the UE's UPU capabilities (e.g., the UPU data type(s) supported by the UE 205). This may be beneficial in order to determine in the UDM/UDR 407 whether the UE 205 supports specific UPU capabilities, e.g., SoR-NS, SimulPLMNsReg, configuration version ID or subscribed S-NSSAIs.

The UDM/UDR 407 may send a new UPU capability request container message, or an existing UPU message may be used with a new request for UPU capability indication. When the UE receives the request, the UE sends a response including the UPU capabilities, e.g., the supported UPU data type(s) like SoR-NS, SimulPLMNsReg or configuration version ID, subscribed S-NSSAIs, default configured NSSAI, Routing Indicator Data, Network Slice-Specific Authentication and Authorization (“NSSAA”) credentials per S-NSSAI, DN-specific credentials for authentication/authorization of the PDU Session establishment, etc. The capability subscribed S-NSSAIs means that the ME part of the UE 205 may store the subscribed S-NSSAIs information, whereas the subscribed S-NSSAIs have the HPLMN values. In summary, the UDM/UDR may be aware in advance (i.e., before initiating the procedure in steps 6, 7 and 8) about the UE capabilities to receive and process slice-based network selection information or authorization for simultaneous VPLMN registration information.

At Step 6, the UDM/UDR 407 determines that the UE configuration for the network selection has to be updated (see block 431). This update may include the slice-based network 20) selection information and/or authorization and configuration for simultaneous VPLMN registration (denoted for simplicity as “slice-based network configuration data”). The UDM/UDR 407 may determine to update the UE 205 based on one or more of the following:
a received or stored UE capability indicating support of slice-based network selection information (e.g., SoR-NS) or simultaneous VPLMN registrations (e.g., SimulPLMNsReg=yes). For example, this is based on the UE UPU capability received in step 3 or in step 5b.
the UE's current location, e.g., the country where the UE 205 is currently located. The country may be identified by the MCC or by other geographical information (e.g., in case of satellite access technology).
the UE's subscribed S-NSSAIs are served by specific VPLMNs (see step 0a).
the UE 205 (i.e., identified by combination of SUPI and IMEI) is not configured yet; or the provided configuration version ID is not valid anymore.

As the network (e.g., HPLMN) needs to consider one or more of the criteria listed above, the list of the preferred PLMN/access technology combinations is not necessarily the same at all times and for all users. The “slice-based network configuration data” (e.g., including list of the preferred PLMN/access technology combinations) needs to be dynamically generated, e.g., generated on demand, e.g., by a dedicated Steering of Roaming Application Function (“SoR-AF”) providing operator specific data analytics solutions.

The “slice-based network selection configuration” may contain validity restriction, e.g., the “slice-based network selection configuration” may apply only in a particular geographical area/region (e.g., a specific country) or during a particular time span or time validity. For example, the slice-based network selection information may be associated with a restriction to be applied in a specific country code (e.g., mobile country code, MCC) or during the time span of one or more days.

Continuing on FIG. 4B, the UDM/UDR 407 configures the UE 205 using one of the following variants:

At Step 7, in one variant (A), the UDM/UDR 407 may create and send the “slice-based network selection configuration” information via UE Parameters Update (UPU) procedure (see messaging 433). The “slice-based network selection configuration” may comprise one or more new parameter(s) to be included in the UPU procedure, e.g., these parameters may be slice-based network selection information, authorization for simultaneous VPLMN registration and/or associated validity restriction. The UDM/UDR 407 may apply security, e.g., include security parameters like SoR-MAC-IAUSF and CounterSoR as specified in 3GPP 33,501.

The UDM/UDR 407 may use the UPU procedure by invoking Nudm_SDM_Notification or Nudm_SDM_Get response service operation by including one of the parameters: slice-based network selection configuration, authorization and configuration for simultaneous VPLMN registration, UE's subscribed S-NSSAI(s), acknowledgement indication, security parameters. The parameters included in the UPU procedure may have final destination either the USIM or the ME part of the UE 205. The UDM/UDR 407 includes the new “slice-based network selection configuration” either in UPU transparent container (if the AMF 403 supports UPU transparent container), or in individual new IEs comprising at least one new UE Parameters Update Data (e.g., UPU Data) types.

Upon receiving the Nudm_SDM_Notification message, the AMF 403 sends a DL NAS Transport message to the served UE 205, whereas message includes either the UPU transparent container or the AMF 403 constructs a UPU transparent container based on the individual IEs comprising the UPU Data.

In addition, if the UDM/UDR 407 has not received UE's UPU data capabilities as in step 1, the UDM/UDR 407 may determine to include UPU capability request indication along with the UPU data parameters in the message to the UE 205. This indication means that the UE 205 is requested to report to the UDM/UDR 407 its UPU data capabilities in the response message (see step 10).

When the UDM/UDR 407 receives the UE's UPU data capabilities (as per step 10), the UDM/UDR 407 should store these capabilities in the UE's context in the UDM/UDR 407 and use them for future UPU procedures, i.e., the UDM/UDR 407 can trigger UPU procedure to the UE 205 only for the UPU data types which are supported by the UE 205. These UE's UPU data types capabilities are stored in the UDM/UDR 407 even when the UE 205 is in deregistered state, as long as the association between SUPI and IMEI does not change.

If the UE 205 has indicated “slice-based network selection configuration” version ID, the UDM/UDR 407 may determine whether update to the UE configuration is required. If update is required, the UDM/UDR 407 creates new “slice-based network selection configuration” which is associated with a new version ID.

The UDM/UDR 407 transmits the “slice-based network selection configuration” (e.g., comprising the new parameters) to the UE 205 via the control plane. In one embodiment, the UPU procedure may be performed as described in 3GPP TS 23.502 (v17.2.0), clause 4.20. If the UDM/UDR 407 determines that the currently selected PLMN is associated with low priority, the UDM/UDR 407 may request the UE 205 to transit to IDLE state in order to apply new “slice-based network selection configuration.” Such request to transit to IDLE state is already described in the Steering of Roaming Connected Mode Control Information (“SoR-CMCI”) which enables the HPLMN to control the timing of a UE 205 in connected mode to move to idle mode to perform the steering of roaming, e.g., as described in 3GPP TS 23.122, clause C.1.

In addition, the UDM/UDR 407 may send to the UE 205 the subscribed S-NSSAIs information. This information is used in the UE 205 to know the full set of which S-NSSAIs to which the UE is subscribed and allowed to request. This information is used in step 10.

The response message sent from the UE 205 to the UDM/UDR 407 may include acknowledgement or failure indication whether any of the parameters sent from the UDM/UDR 407 could or could not be processed and/or the result of the security check. The UE 205 may also send its UPU (data types) capability to the UDM/UDR 407 if the UE 205 had not done so in step 1/3 or 5b. Further details are provided in step 10.

At Step 8a, in another variant (B), the UDM/UDR 407 may send a request to the SoR-AF 411 to create the slice-based network selection information (see messaging 435). For this purpose, the UDM/UDR 407 may use the Nsoraf_SoR_Get service operation and send a request message to the SoR-AF 411. The request message may include new indications that slice-based configuration for network selection is required and the list of subscribed S-NSSAIs for this UE 205. The list of subscribed S-NSSAIs is the same as the subscribed S-NSSAIs stored in the UE subscription data.

At Step 8b, based on the received indication for slice-based configuration for network selection and the subscribed S-NSSAIs, the SOR-AF 411 creates slice-based network selection information to be provisioned to the UE 205. One example of such information is already described above where the mapping of network slice to a network ID (e.g., VPLMN/SNPN) in priority order may be included. The SoR-AF 411 may also create and associate a validity restriction for the slice-based network selection information.

The SoR-AF 411 provides the created information in a container to the UDM/UDR 407 called exemplary SoR-NS container (see messaging 437). The SoR-NS container may or may not be encrypted. The SoR-AF 411 may use the Nsoraf_SoR_Get service operation and send a response to the UDM/UDR 407.

At Step 8c, the UDM/UDR 407 may use control plane (“CP”) transport procedure to transmit to the UE 205 the SoR-NS container received from the SoR-AF 411 (see messaging 439). In addition, the UDM/UDR 407 may include authorization for simultaneous VPLMN registration information to the UE 205. The signaling details between UDM/UDR 407 and UE 205 is described in step 7 and can be re-used in this step as well. Note that the response message received from the UE 205 is described in step 10.

Please note that a combination of variants (A) and (B), i.e., of steps 7 and 8, may also apply. In other words, some information (e.g., slice-based network selection information and optionally the associated validity restriction) may be created in the SoR-AF 411, whereas other information (e.g., authorization for simultaneous VPLMN registration) is created in the UDM/UDR 407.

At Step 9, the UDM/UDR 407 stores for the UE 205 (i.e., identified by the combination of SUPI and IMEI) that authorization and configuration for simultaneous VPLMN registration has been successfully provided to the UE 205 (see block 441).

At Step 10, upon receiving the DL NAS Transport message, the UE 205 attempts to verify the validity of the received UPU data (see block 443). If the verification is successful, then the UE 205 processes the UPU data as follows:
if the UPU data contains parameters protected by secured packet (e.g., encrypted by the Secure Packet Application Function (“SP-AF”)), the ME forwards the secured packet to the USIM. For example, the slice-based network selection information (e.g., including the mapping of network slice to a network ID (e.g., VPLMN/SNPN) in priority order) can be stored in the USIM.
if the UPU data contains parameters not protected by secure packet, then the UE 205 updates and stores the received parameters in the ME, e.g., in the UDM/UDR 407 Update Data set. In other words, the UE 205 may store the slice-based network selection information or the authorization for simultaneous PLMN registration as a new data sets in the UDM/UDR 407 Update Data in the ME.

The UE 205 checks whether the received UPU data set type(s) (e.g., slice-based network selection information and/or authorization and configuration for simultaneous VPLMN registration) are supported in the UE 205. For example, the UE 205 may perform intern capability match between the UE's support of various UPU data types and the received UPU data type(s). If the check is positive, the UE 205 stores or updates the received UPU data type(s).

The UE 205 may generate and send a response message (e.g., acknowledgement) to the UDM/UDR 407. In case that the UE 205 did not provide UPU data types capability as in step 1, then the UE 205 sends in the response message to the UDM/UDR 407 the UPU data type check result (e.g., positive or negative) about the received UPU data types. In addition, the UE 205 may provide an indication about the supported UE parameters update (“UPU”) data set types to the UDM/UDR 407, i.e., all supported data types (or features) supported in the UE 205.

At Step 11, following the successful update, the UE 205 performs network selection according to the configuration in step 10, i.e., by applying the “slice-based network selection configuration” information for network selection (see block 445). The processing in the UE 205 is described in detail in FIG. 3. If the “slice-based network selection configuration” is associated with a validity restriction parameter (e.g., location or time restriction), the UE 205 applies the configuration when the validity restriction is fulfilled.

The UE 205 behavior and processing of the “slice-based network selection configuration” information is described in the example for the mapping of network slice to a network ID (e.g., VPLMN/SNPN) in priority order information and in FIG. 3.

Below is a summary about the options how the UE 205 can provide its UPU capability (e.g., UPU data types supported) to the UDM/UDR 407:
during the registration procedure (e.g., step 1 and 3);
during a dedicated UPU procedure for capability check (or UPU capability match procedure) as per step 5b; or
during the UPU response from the UE 205 to UDM/UDR 407 (e.g., steps 7 or 8c).

The benefit of the solution in FIGS. 4A-4B is that the home network (e.g., UDM/UDR 407 in the HPLMN, SNPN or CH) is able to update on demand the UE configuration for slice-based network selection. After the UDM/UDR 407 determines that the UE configuration update is required, the UDM/UDR 407 initiates control plane configuration procedure (UPU procedure). By using the “slice-based network selection configuration” information, the UE 205 is enabled to select a network according to the desired (preferred) network slice.

The disadvantage of the proposed solution is that the UE 205 may need to re-select another network (e.g., VPLMN or SNPN) when another preferred S-NSSAI(s) is determined in the UE 205. On the other hand, the UE 205 is enabled to always obtain network access to the preferred/desired service (i.e., S-NSSAIs), as without the proposed solution, the UE 205 would get access to a subset of the subscribed S-NSSAIs.

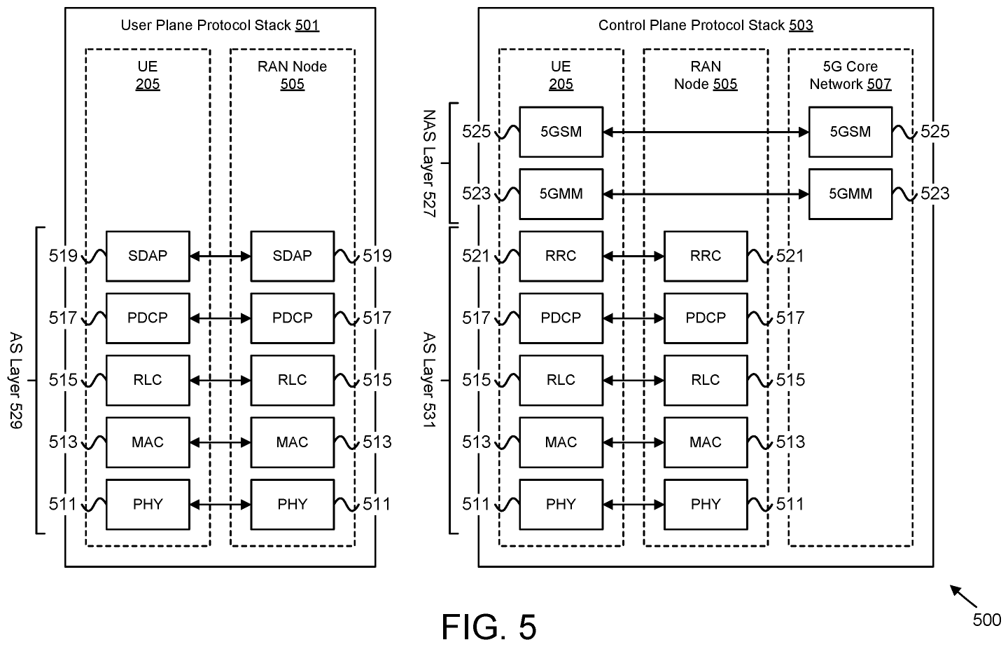

FIG. 5 depicts a protocol stack 500, according to embodiments of the disclosure. While FIG. 5 shows a UE 205, a RAN node 505 and a 5G core network (“5GC”) 507, these are representative of a set of remote units 105 interacting with a base station (e.g., cellular base unit 121) and a mobile core network 140. As discussed above, the UE 205 may be an embodiment of the remote unit 105, while the RAN node 505 may be an embodiment of the cellular base unit 121 and/or the access point 131, and the 5GC 507 may be include an embodiment of the AMF 143 and/or the SMF 145.

As depicted, the protocol stack 500 comprises a User Plane protocol stack 501 and a Control Plane protocol stack 503. The User Plane protocol stack 501 includes a physical (“PHY”) layer 511, a Medium Access Control (“MAC”) sublayer 513, the Radio Link Control (“RLC”) sublayer 515, a Packet Data Convergence Protocol (“PDCP”) sublayer 517, and Service Data Adaptation Protocol (“SDAP”) layer 519. The AS layer 529 (also referred to as “AS protocol stack”) for the User Plane protocol stack 501 consists of at least SDAP, PDCP, RLC and MAC sublayers, and the physical layer.

The Control Plane protocol stack 503 includes a physical layer 511, a MAC sublayer 513, a RLC sublayer 515, and a PDCP sublayer 517. The Control Place protocol stack 503 also includes a Radio Resource Control (“RRC”) layer 521, a 5GS Mobility Management (“5GMM”) sublayer 523 and the 5GS Session Management (“5GSM”) sublayer 525, which comprise a Non-Access Stratum (“NAS”) layer 527. The AS layer 531 for the Control Plane protocol stack 503 consists of at least RRC, PDCP, RLC and MAC sublayers, and the physical layer.

The Layer-2 (“L2”) is split into the SDAP, PDCP, RLC and MAC sublayers. The Layer-3 (“L3”) includes the RRC sublayer 521 and the NAS layer 527 for the control plane and includes, e.g., an Internet Protocol (“IP”) layer or PDU Layer (note depicted) for the user plane. L1 and L2 are referred to as “lower layers,” while L3 and above (e.g., transport layer, application layer) are referred to as “higher layers” or “upper layers.”

The physical layer 511 offers transport channels to the MAC sublayer 513, while the MAC sublayer 513 offers logical channels to the RLC sublayer 515. The RLC sublayer 515 offers RLC channels to the PDCP sublayer 517 and the PDCP sublayer 517 offers radio bearers to the SDAP sublayer 719 and/or RRC layer 521. The SDAP sublayer 519 offers QoS flows to the core network (e.g., 5G core network 507). The RRC layer 521 provides for the addition, modification, and release of Carrier Aggregation and/or Dual Connectivity. The RRC layer 521 also manages the establishment, configuration, maintenance, and release of Signaling Radio Bearers (“SRBs”) and Data Radio Bearers (“DRBs”).

The 5GMM sublayer 523 is used to track the location of the UE 205 (e.g., Cell-ID or Tracking Area) and to manage the UE registration/authentication state in the 5GS. The 5GMM sublayer 523 also manages 5G NAS security, such as integrity protection and ciphering. The 5GSM sublayer 525 is used for PDU session handling in the 5GC, including PDU session establishment, PDU session modification and PDU session release. Various states and procedures for 5GMM and 5GSM are defined in 3GPP TS 24.501, clause 5.

The NAS layer 527 is between the UE 205 and the 5GC 507 (i.e., AMF 143). NAS messages are passed transparently through the (R) AN. The NAS layer 527 is used to manage the establishment of communication sessions and for maintaining continuous communications with the UE 205 as it moves between different cells of the (R) AN. In contrast, the AS layer 529/531 is between the UE 205 and the 5G-(R) AN (i.e., RAN node 505) and carries information over the access network portion of the network.

Regarding the available network selection mechanism, steering of UE to particular networks, especially in roaming situations, is supported by the network selection procedure specified in 3GPP TS 23.122. In particular the automatic network selection uses an “Operator controlled PLMN selector with Access Technology” list (aka list of preferred PLMN/access technology combinations) which can be stored in the USIM profile and/or in the ME (mobile equipment). The format of the “Operator controlled PLMN selector with Access Technology” list is specified in Table 3, as follows:

TABLE 3
Operator controlled PLMN selector with Access Technology

Identifier: ‘6F61’ Structure: transparent Optional
SFI: ‘11’
File size: 5n bytes, (n ≥ 8) Update activity: low

| Access Conditions: | |
|---|---|
| READ | PIN |
| UPDATE | ADM |
| DEACTIVATE | ADM |
| ACTIVATE | ADM |

| Bytes | Description | M/O | Length |
|---|---|---|---|
| 1 to 3 | 1^{st} PLMN (highest priority) | M | 3 bytes |
| 4 to 5 | 1^{st} PLMN Access Technology | M | 2 bytes |
| | Identifier | | |
| . | . | | |
| . | . | | |
| . | . | | |
| 36 to 38 | 8^{th} PLMN | M | 3 bytes |
| 39 to 40 | 8^{th} PLMN Access Technology | M | 2 bytes |
| | Identifier | | |
| 41 to 43 | 9^{th} PLMN | O | 3 bytes |
| 44 to 45 | 9^{th} PLMN Access Technology | O | 2 bytes |
| | Identifier | | |
| . | . | | |
| . | . | | |
| . | . | | |
| (5n-4) to (5n-2) | N^{th} PLMN (lowest priority) | O | 3 bytes |
| (5n-1) to 5n | N^{th} PLMN Access Technology | O | 2 bytes |
| | Identifier | | |

For each PLMN ID there are associated 16 bits (2 bytes) which can be set to indicate one or more radio access technologies which the UE is allowed to use in this PLMN. In addition to the pre-configured lists of PLMNs in the USIM profile, the HPLMN may provide the steering of roaming (“SoR”) information to the UE using the control plane (“CP”) mechanism specified in 5GS (for UEs in N1 mode of operation). This allows on-demand update of the list of PLMNs (e.g., “Operator controlled PLMN selector with Access Technology” list) for network selection.

The HPLMN is able to update the UE configuration by executing the SoR procedure. One example procedure for providing list of preferred PLMN/access technology combinations and the SoR-CMCI is specified TS 23.122 in annex C. The UDM in the HPLMN determine whether to perform the SoR procedure (e.g., in step 3 of the procedure specified in TS 23.122) based on internal configuration in the UDM. The UDM may trigger the SoR-AF to generate the SoR information to be sent to the UE. The SoR information has the same format as the “Operator controlled PLMN selector with Access Technology” list described above.

Regarding SoR-AF interactions, the SoR-AF reference model indicates that an NF consumer (e.g., UDM) can request SoR information from the SoR-AF, e.g., using the Nsoraf service operation as described in 3GPP TS 29.550. In some embodiments, the SoR-AF can be deployed in the network operator domain, i.e., in the trusted network domain where also the UDM is located.

The information sent from the UDM or SoR-AF to the UE may have the final consumer destination to be the USIM in the UE. In such case, the UE parameters need to be protected in a secure packet. The secure packet may be created by the SP-AF network function and the SP-AF may use keys for over-the-air (“OTA”) provisioning. Note that the SP-AF may support the Nspaf service operation, e.g., as described in 3GPP TS 29.544.

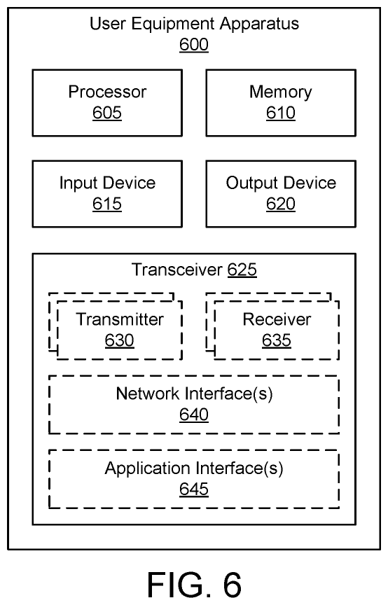

FIG. 6 depicts a user equipment apparatus 600 that may be used for steering a device to networks supporting specific network slices, according to embodiments of the disclosure. In various embodiments, the user equipment apparatus 600 is used to implement one or more of the solutions described above. The user equipment apparatus 600 may be one embodiment of the remote unit 105 and/or the UE 205, described above. Furthermore, the user equipment apparatus 600 may include a processor 605, a memory 610, an input device 615, an output device 620, and a transceiver 625.

In some embodiments, the input device 615 and the output device 620 are combined into a single device, such as a touchscreen. In certain embodiments, the user equipment apparatus 600 may not include any input device 615 and/or output device 620. In various embodiments, the user equipment apparatus 600 may include one or more of: the processor 605, the memory 610, and the transceiver 625, and may not include the input device 615 and/or the output device 620.

As depicted, the transceiver 625 includes at least one transmitter 630 and at least one receiver 635. In some embodiments, the transceiver 625 communicates with one or more cells (or wireless coverage areas) supported by one or more cellular base units 121 and/or access points 131. In various embodiments, the transceiver 625 is operable on unlicensed spectrum. Moreover, the transceiver 625 may include multiple UE panels supporting one or more beams. Additionally, the transceiver 625 may support at least one network interface 640 and/or application interface 645. The application interface(s) 645 may support one or more APIs. The network interface(s) 640 may support 3GPP reference points, such as Uu, N1, PC5, etc. Other network interfaces 640 may be supported, as understood by one of ordinary skill in the art.

The processor 605, in one embodiment, may include any known controller capable of executing computer-readable instructions and/or capable of performing logical operations. For example, the processor 605 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 605 executes instructions stored in the memory 610 to perform the methods and routines described herein. The processor 605 is communicatively coupled to the memory 610, the input device 615, the output device 620, and the transceiver 625.

In various embodiments, the processor 605 controls the user equipment apparatus 600 to implement the above described UE behaviors. In certain embodiments, the processor 605 may include an application processor (also known as “main processor”) which manages application-domain and operating system (“OS”) functions and a baseband processor (also known as “baseband radio processor”) which manages radio functions.

In various embodiments, the processor 605 controls the transceiver 625 send a first message to the communication network, said first message comprising an indication (i.e., at least one indication) of a UE capability to support slice-based network selection (e.g., SoR-NS or mapping of network slice to network ID). The transceiver 625 receives a second message from the communication network, said second message comprising slice-based network selection information (e.g., configuration information about the mapping between a network slice ID and network ID where it is available). The processor 605 stores the received slice-based network selection information and performs slice-based network selection procedure according to the received slice-based network selection information.

In some embodiments, the first message comprises a NAS MM message (e.g., a Registration Request message including the information of 5GMM capability or UE parameters update capabilities). In some embodiments, the first message is sent in response to a capability request from the network (e.g., from UDM). In some embodiments, the slice-based network selection information comprises a mapping of a network slice to a prioritized list of network identifiers. In some embodiments, the slice-based network selection information comprises a mapping of a network identifier to a network slice and associated priority.

In some embodiments, the performing slice-based network selection procedure according to the received slice-based network selection information includes: A) identifying available networks; B) determining whether at least one available network supports all subscribed network slices of the UE; C) applying operator-controlled network selection information to select a single network when at least one available network supports all the subscribed network slices; D) applying the slice-based network selection information to select a network that supports a set of preferred network slices of the UE when no available network supports all the subscribed network slices; and E) performing a registration procedure with the selected network. In such embodiments, the registration procedure is of type ‘additional’ when simultaneous registration with multiple networks is allowed; however, the registration procedure is one of: type ‘initial’ or type ‘mobility,’ when simultaneous registration with multiple networks is not allowed.

In certain embodiments, the UE's subscribed network slices include a list of all network slices from a URSP, where the set of preferred network slices of the UE includes one or more network slices mapped to a preferred user service using the URSP. Here, the preferred user service results from a connectivity request from an upper layer entity (e.g., service(s) and/or application(s)), a default service, or combinations thereof. In certain embodiments, the processor 605 derives the subscribed network slices of the UE by performing one of: A) identifying all S-NSSAIs for which there is mapping information in the slice-based network selection information; B) identifying all S-NSSAIs for which there is a route selection descriptor in set of the URSP rules stored in the UE; or C) identifying a configured NSSAI for a HPLMN of the UE.

In some embodiments, the first message further indicates a UE capability to support simultaneous registrations with multiple networks and the second message contains an indication that simultaneous registration with multiple networks is allowed. In such embodiments, performing network selection procedure according to the received slice-based network selection information includes the processor 605 selecting a plurality of networks, where the processor 605 performs simultaneous registration with the selected plurality of networks. Here, the selected plurality of networks collectively supports the network slices which the UE wants to use.

The memory 610, in one embodiment, is a computer readable storage medium. In some embodiments, the memory 610 includes volatile computer storage media. For example, the memory 610 may include a RAM, including dynamic RAM (“DRAM”), synchronous dynamic RAM (“SDRAM”), and/or static RAM (“SRAM”). In some embodiments, the memory 610 includes non-volatile computer storage media. For example, the memory 610 may include a hard disk drive, a flash memory, or any other suitable non-volatile computer storage device. In some embodiments, the memory 610 includes both volatile and non-volatile computer storage media.

In some embodiments, the memory 610 stores data related to steering a device to networks supporting specific network slices and/or mobile operation. For example, the memory 610 may store various parameters, panel/beam configurations, resource assignments, policies, and the like as described above. In certain embodiments, the memory 610 also stores program code and related data, such as an operating system or other controller algorithms operating on the apparatus 600.

The input device 615, in one embodiment, may include any known computer input device including a touch panel, a button, a keyboard, a stylus, a microphone, or the like. In some embodiments, the input device 615 may be integrated with the output device 620, for example, as a touchscreen or similar touch-sensitive display. In some embodiments, the input device 615 includes a touchscreen such that text may be input using a virtual keyboard displayed on the touchscreen and/or by handwriting on the touchscreen. In some embodiments, the input device 615 includes two or more different devices, such as a keyboard and a touch panel.

The output device 620, in one embodiment, is designed to output visual, audible, and/or haptic signals. In some embodiments, the output device 620 includes an electronically controllable display or display device capable of outputting visual data to a user. For example, the output device 620 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 620 may include a wearable display separate from, but communicatively coupled to, the rest of the user equipment apparatus 600, such as a smart watch, smart glasses, a heads-up display, or the like. Further, the output device 620 may be a component of a smart phone, a personal digital assistant, a television, a table computer, a notebook (laptop) computer, a personal computer, a vehicle dashboard, or the like.

In certain embodiments, the output device 620 includes one or more speakers for producing sound. For example, the output device 620 may produce an audible alert or notification (e.g., a beep or chime). In some embodiments, the output device 620 includes one or more haptic devices for producing vibrations, motion, or other haptic feedback. In some embodiments, all or portions of the output device 620 may be integrated with the input device 615. For example, the input device 615 and output device 620 may form a touchscreen or similar touch-sensitive display. In other embodiments, the output device 620 may be located near the input device 615.

The transceiver 625 communicates with one or more network functions of a mobile communication network via one or more access networks. The transceiver 625 operates under the control of the processor 605 to transmit messages, data, and other signals and also to receive messages, data, and other signals. For example, the processor 605 may selectively activate the transceiver 625 (or portions thereof) at particular times in order to send and receive messages.

The transceiver 625 includes at least transmitter 630 and at least one receiver 635. One or more transmitters 630 may be used to provide UL communication signals to a cellular base unit 121 and/or access point 131, such as the UL transmissions described herein. Similarly, one or more receivers 635 may be used to receive DL communication signals from the cellular base unit 121 and/or access point 131, as described herein. Although only one transmitter 630 and one receiver 635 are illustrated, the user equipment apparatus 600 may have any suitable number of transmitters 630 and receivers 635. Further, the transmitter(s) 630 and the receiver(s) 635 may be any suitable type of transmitters and receivers. In one embodiment, the transceiver 625 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 625, transmitters 630, and receivers 635 may be implemented as physically separate components that access a shared hardware resource and/or software resource, such as for example, the network interface 640.

In various embodiments, one or more transmitters 630 and/or one or more receivers 635 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 630 and/or one or more receivers 635 may be implemented and/or integrated into a multi-chip module. In some embodiments, other components such as the network interface 640 or other hardware components/circuits may be integrated with any number of transmitters 630 and/or receivers 635 into a single chip. In such embodiment, the transmitters 630 and receivers 635 may be logically configured as a transceiver 625 that uses one more common control signals or as modular transmitters 630 and receivers 635 implemented in the same hardware chip or in a multi-chip module.

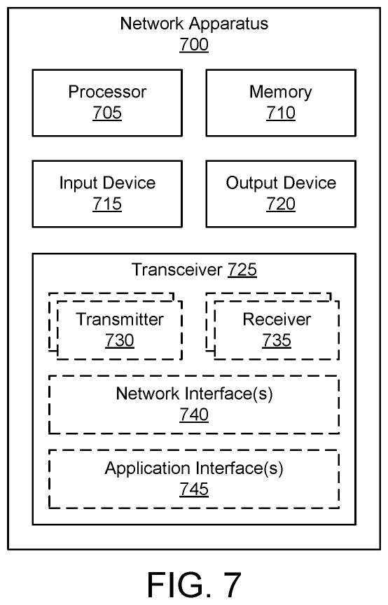

FIG. 7 depicts a network apparatus 700 that may be used for steering a device to networks supporting specific network slices, according to embodiments of the disclosure. In one embodiment, network apparatus 700 may be one implementation of a data management entity in a mobile communication network, such as the UDM/UDR 149, the UDM 240, and/or the UDM/UDR 407, as described above. Furthermore, the network apparatus 700 may include a processor 705, a memory 710, an input device 715, an output device 720, and a transceiver 725.

In some embodiments, the input device 715 and the output device 720 are combined into a single device, such as a touchscreen. In certain embodiments, the network apparatus 700 may not include any input device 715 and/or output device 720. In various embodiments, the network apparatus 700 may include one or more of: the processor 705, the memory 710, and the transceiver 725, and may not include the input device 715 and/or the output device 720.

As depicted, the transceiver 725 includes at least one transmitter 730 and at least one receiver 735. Here, the transceiver 725 communicates with one or more remote units 105. Additionally, the transceiver 725 may support at least one network interface 740 and/or application interface 745. The application interface(s) 745 may support one or more APIs. The network interface(s) 740 may support 3GPP reference points, such as Uu, N1, N2 and N3. Other network interfaces 740 may be supported, as understood by one of ordinary skill in the art.

The processor 705, in one embodiment, may include any known controller capable of executing computer-readable instructions and/or capable of performing logical operations. For example, the processor 705 may be a microcontroller, a microprocessor, a CPU, a GPU, an auxiliary processing unit, a FPGA, or similar programmable controller. In some embodiments, the processor 705 executes instructions stored in the memory 710 to perform the methods and routines described herein. The processor 705 is communicatively coupled to the memory 710, the input device 715, the output device 720, and the transceiver 725.

In various embodiments, the network apparatus 700 is a RAN node (e.g., gNB) that communicates with one or more UEs, as described herein. In such embodiments, the processor 705 controls the network apparatus 700 to perform the above described RAN behaviors. When operating as a RAN node, the processor 705 may include an application processor (also known as “main processor”) which manages application-domain and operating system (“OS”) functions and a baseband processor (also known as “baseband radio processor”) which manages radio functions.

In various embodiments, the network apparatus 700 is a UDM (e.g., the UDM/UDR 149, UDM 240, and/or UDM/UDR 407) that communicates with one or more NFs in a mobile communication network (e.g., via a transceiver 725 and/or network interface 740), as described herein. In such embodiments, the processor 705 controls the network apparatus 700 to perform the above described UDM behaviors. In some embodiments, the processor 705 controls the transceiver 725 to receive (e.g., via a network interface 740) a first message indicating that a UE registers with a second communication network and a processor 705 that determines slice-based network selection information for the UE and provisions the UE with the slice-based network selection information (e.g., configuration information about the mapping between a network slice ID and network ID).

In some embodiments, the first message further indicates that the UE supports slice-based network selection (e.g., SoR-NS or mapping of network slice to network ID) and that the UE supports simultaneous registrations with multiple networks. In certain embodiments, the transceiver 725 sends an indication to the UE that simultaneous registration with multiple networks is allowed and the processor 705 stores an indication that the UE is authorized for simultaneous registration with multiple networks. In some embodiments, the processor 705 stores an indication that the UE has been successfully provisioned with the slice-based network selection information.

In some embodiments, the transceiver 725 receives a network configuration that a specific network slice is supported in a set of specific networks and the processor 705 stores the received network configuration. In some embodiments, determining the slice-based network selection information includes mapping each network slice to which the UE is subscribed to a specific network, where at least one network slice to which the UE is subscribed is not supported in the second network (e.g., but is supported in a third network).

In some embodiments, provisioning the UE with the slice-based network selection information includes performing a UE parameter update procedure and/or triggering a provisioning server (e.g., SoR-AF) to update a UE configuration of the UE with the slice-based network selection information.

The memory 710, in one embodiment, is a computer readable storage medium. In some embodiments, the memory 710 includes volatile computer storage media. For example, the memory 710 may include a RAM, including dynamic RAM (“DRAM”), synchronous dynamic RAM (“SDRAM”), and/or static RAM (“SRAM”). In some embodiments, the memory 710 includes non-volatile computer storage media. For example, the memory 710 may include a hard disk drive, a flash memory, or any other suitable non-volatile computer storage device. In some embodiments, the memory 710 includes both volatile and non-volatile computer storage media.

In some embodiments, the memory 710 stores data related to steering a device to networks supporting specific network slices and/or mobile operation. For example, the memory 710 may store parameters, configurations, resource assignments, policies, and the like, as described above. In certain embodiments, the memory 710 also stores program code and related data, such as an operating system or other controller algorithms operating on the apparatus 700.

The input device 715, in one embodiment, may include any known computer input device including a touch panel, a button, a keyboard, a stylus, a microphone, or the like. In some embodiments, the input device 715 may be integrated with the output device 720, for example, as a touchscreen or similar touch-sensitive display. In some embodiments, the input device 715 includes a touchscreen such that text may be input using a virtual keyboard displayed on the touchscreen and/or by handwriting on the touchscreen. In some embodiments, the input device 715 includes two or more different devices, such as a keyboard and a touch panel.

The output device 720, in one embodiment, is designed to output visual, audible, and/or haptic signals. In some embodiments, the output device 720 includes an electronically controllable display or display device capable of outputting visual data to a user. For example, the output device 720 may include, but is not limited to, an LCD display, an LED display, an OLED display, a projector, or similar display device capable of outputting images, text, or the like to a user. As another, non-limiting, example, the output device 720 may include a wearable display separate from, but communicatively coupled to, the rest of the network apparatus 700, such as a smart watch, smart glasses, a heads-up display, or the like. Further, the output device 720 may be a component of a smart phone, a personal digital assistant, a television, a table computer, a notebook (laptop) computer, a personal computer, a vehicle dashboard, or the like.

In certain embodiments, the output device 720 includes one or more speakers for producing sound. For example, the output device 720 may produce an audible alert or notification (e.g., a beep or chime). In some embodiments, the output device 720 includes one or more haptic devices for producing vibrations, motion, or other haptic feedback. In some embodiments, all or portions of the output device 720 may be integrated with the input device 715. For example, the input device 715 and output device 720 may form a touchscreen or similar touch-sensitive display. In other embodiments, the output device 720 may be located near the input device 715.

The transceiver 725 includes at least transmitter 730 and at least one receiver 735. One or more transmitters 730 may be used to communicate with the UE, as described herein. Similarly, one or more receivers 735 may be used to communicate with network functions in the Public Land Mobile Network (“PLMN”) and/or RAN, as described herein. Although only one transmitter 730 and one receiver 735 are illustrated, the network apparatus 700 may have any suitable number of transmitters 730 and receivers 735. Further, the transmitter(s) 730 and the receiver(s) 735 may be any suitable type of transmitters and receivers.

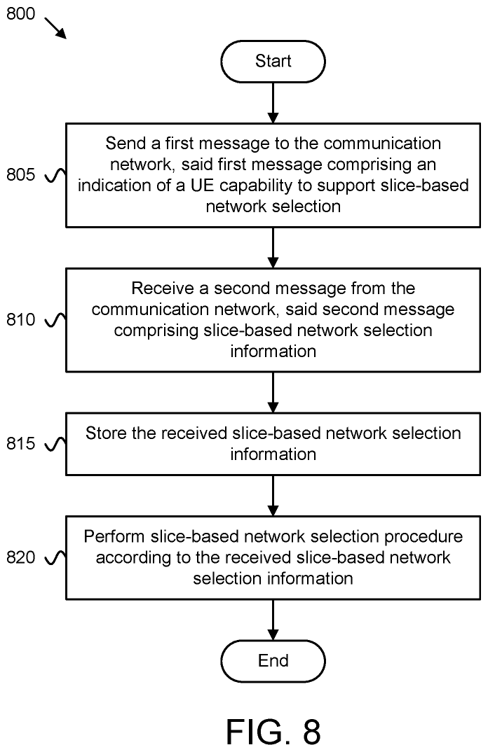

FIG. 8 depicts one embodiment of a method 800 for steering a device to networks supporting specific network slices, according to embodiments of the disclosure. In various embodiments, the method 800 is performed by a UE device, such as the remote unit 105, the UE 205, and/or the user equipment apparatus 600, described above as described above. In some embodiments, the method 800 is performed by a processor, such as a microcontroller, a microprocessor, a CPU, a GPU, an auxiliary processing unit, a FPGA, or the like.

The method 800 begins and sends 805 a first message to the communication network, said first message comprising an indication (i.e., at least one indication) of a UE capability to support slice-based network selection (e.g., SoR-NS or mapping of network slice to network ID). The method 800 includes receiving 810 a second message from the communication network, said second message comprising slice-based network selection information (e.g., configuration information about the mapping between a network slice ID and network ID where it is available). The method 800 includes storing 815 the received slice-based network selection information. The method 800 includes performing 820 slice-based network selection procedure according to the received slice-based network selection information. The method 800 ends.

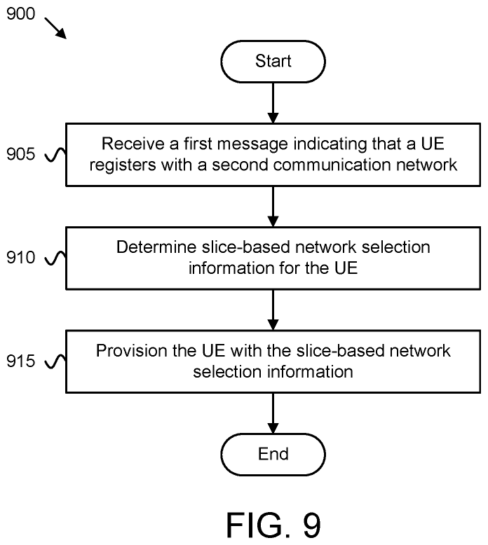

FIG. 9 depicts one embodiment of a method 900 for steering a device to networks supporting specific network slices, according to embodiments of the disclosure. In various embodiments, the method 900 is performed by a data management entity in a mobile communication network, such as the UDM/UDR 149, the UDM 240, the UDM/UDR 407, and/or the network apparatus 700, described above as described above. In some embodiments, the method 900 is performed by a processor, such as a microcontroller, a microprocessor, a CPU, a GPU, an auxiliary processing unit, a FPGA, or the like.

The method 900 begins and receives 905 a first message indicating that a UE registers with a second communication network. The method 900 includes determining 910 slice-based network selection information for the UE. The method 900 includes provisioning 915 the UE with the slice-based network selection information (e.g., configuration information about the mapping between a network slice ID and network ID). The method 900 ends.

Disclosed herein is a first apparatus for performing signaling exchange (e.g., a registration procedure) with a communication network, according to embodiments of the disclosure. The first apparatus may be implemented by a UE device, such as the remote unit 105, the UE 205, and/or the user equipment apparatus 600, described above. The first apparatus includes a processor and a transceiver that sends a first message to the communication network, said first message comprising an indication (i.e., at least one indication) of a UE capability to support slice-based network selection (e.g., SoR-NS or mapping of network slice to network ID). The transceiver receives a second message from the communication network, said second message comprising slice-based network selection information (e.g., configuration information about the mapping between a network slice ID and network ID where it is available). The processor stores the received slice-based network selection information and performs slice-based network selection procedure according to the received slice-based network selection information.

In some embodiments, the first message comprises a NAS MM message (e.g., a Registration Request message including the information of 5GMM capability or UE parameters update capabilities). In some embodiments, the first message is sent in response to a capability request from the network (e.g., from UDM). In some embodiments, the slice-based network selection information comprises a mapping of a network slice to a prioritized list of network identifiers. In some embodiments, the slice-based network selection information comprises a mapping of a network identifier to a network slice and associated priority.

In some embodiments, the performing slice-based network selection procedure according to the received slice-based network selection information includes: A) identifying available networks; B) determining whether at least one available network supports all subscribed network slices of the UE; C) applying operator-controlled network selection information to select a single network when at least one available network supports all the subscribed network slices; D) applying the slice-based network selection information to select a network that supports a set of preferred network slices of the UE when no available network supports all the subscribed network slices; and E) performing a registration procedure with the selected network. In such embodiments, the registration procedure is of type ‘additional’ when simultaneous registration with multiple networks is allowed; however, the registration procedure is one of: type ‘initial’ or type ‘mobility,’ when simultaneous registration with multiple networks is not allowed.

In certain embodiments, the UE's subscribed network slices include a list of all network slices from a URSP, where the set of preferred network slices of the UE includes one or more network slices mapped to a preferred user service using the URSP. Here, the preferred user service results from a connectivity request from an upper layer entity (e.g., service(s) and/or application(s)), a default service, or combinations thereof. In certain embodiments, the processor derives the subscribed network slices of the UE by performing one of: A) identifying all S-NSSAIs for which there is mapping information in the slice-based network selection information; B) identifying all S-NSSAIs for which there is a route selection descriptor in set of the URSP rules stored in the UE; or C) identifying a configured NSSAI for a HPLMN of the UE.

In some embodiments, the first message further indicates a UE capability to support simultaneous registrations with multiple networks and the second message contains an indication that simultaneous registration with multiple networks is allowed. In such embodiments, performing network selection procedure according to the received slice-based network selection information includes the processor selecting a plurality of networks, where the processor performs simultaneous registration with the selected plurality of networks. Here, the selected plurality of networks collectively supports the network slices which the UE wants to use.

Disclosed herein is a first method for performing signaling exchange (e.g., a registration procedure) with a communication network, according to embodiments of the disclosure. The first method may be performed by a UE device, such as the remote unit 105, the UE 205, and/or the user equipment apparatus 600, described above. The first method includes sending a first message to the communication network, said first message comprising an indication (i.e., at least one indication) of a UE capability to support slice-based network selection (e.g., SoR-NS or mapping of network slice to network ID). The first method includes receiving a second message from the communication network, said second message comprising slice-based network selection information (e.g., configuration information about the mapping between a network slice ID and network ID where it is available). The first method includes storing the received slice-based network selection information and performing slice-based network selection procedure according to the received slice-based network selection information.

In some embodiments, the first message comprises a NAS MM message (e.g., a Registration Request message including the information of 5GMM capability or UE parameters update capabilities). In some embodiments, the first message is sent in response to a capability request from the network (e.g., from UDM). In some embodiments, the slice-based network selection information comprises a mapping of a network slice to a prioritized list of network identifiers. In some embodiments, the slice-based network selection information comprises a mapping of a network identifier to a network slice and associated priority.

In some embodiments, the performing slice-based network selection procedure according to the received slice-based network selection information includes: A) identifying available networks; B) determining whether at least one available network supports all subscribed network slices of the UE; C) applying operator-controlled network selection information to select a single network when at least one available network supports all the subscribed network slices; D) applying the slice-based network selection information to select a network that supports a set of preferred network slices of the UE when no available network supports all the subscribed network slices; and E) performing a registration procedure with the selected network. In such embodiments, the registration procedure is of type ‘additional’ when simultaneous registration with multiple networks is allowed; however, the registration procedure is one of: type ‘initial’ or type ‘mobility,’ when simultaneous registration with multiple networks is not allowed.

In certain embodiments, the UE's subscribed network slices include a list of all network slices from a URSP, where the set of preferred network slices of the UE includes one or more network slices mapped to a preferred user service using the URSP. Here, the preferred user service results from a connectivity request from an upper layer entity (e.g., service(s) and/or application(s)), a default service, or combinations thereof. In certain embodiments, the first method includes deriving the subscribed network slices of the UE by performing one of: A) identifying all S-NSSAIs for which there is mapping information in the slice-based network selection information; B) identifying all S-NSSAIs for which there is a route selection descriptor in set of the URSP rules stored in the UE; or C) identifying a configured NSSAI for a HPLMN of the UE.

In some embodiments, the first message further indicates a UE capability to support simultaneous registrations with multiple networks and the second message contains an indication that simultaneous registration with multiple networks is allowed. In such embodiments, performing network selection procedure according to the received slice-based network selection information includes selecting a plurality of networks, the first method further including performing simultaneous registration with the selected plurality of networks. Here, the selected plurality of networks collectively supports the network slices which the UE wants to use.

Disclosed herein is a second apparatus for steering a device to networks supporting specific network slices, according to embodiments of the disclosure. The second apparatus may be implemented by a data management entity in a mobile communication network, such as the UDM/UDR 149, the UDM 240, the UDM/UDR 407, and/or the network apparatus 700, described above. The second apparatus includes a transceiver (i.e., implementing a network interface) that receives a first message indicating that a UE registers with a second communication network and a processor that determines slice-based network selection information for the UE and provisions the UE with the slice-based network selection information (e.g., configuration information about the mapping between a network slice ID and network ID).

In some embodiments, the first message further indicates that the UE supports slice-based network selection (e.g., SoR-NS or mapping of network slice to network ID) and that the UE supports simultaneous registrations with multiple networks. In certain embodiments, the transceiver sends an indication to the UE that simultaneous registration with multiple networks is allowed and the processor stores an indication that the UE is authorized for simultaneous registration with multiple networks. In some embodiments, the processor stores an indication that the UE has been successfully provisioned with the slice-based network selection information.

In some embodiments, the transceiver receives a network configuration that a specific network slice is supported in a set of specific networks and the processor stores the received network configuration. In some embodiments, determining the slice-based network selection information includes mapping each network slice to which the UE is subscribed to a specific network, where at least one network slice to which the UE is subscribed is not supported in the second network (e.g., but is supported in a third network).

In some embodiments, provisioning the UE with the slice-based network selection information includes performing a UE parameter update procedure and/or triggering a provisioning server (e.g., SoR-AF) to update a UE configuration of the UE with the slice-based network selection information.

Disclosed herein is a second method for steering a device to networks supporting specific network slices, according to embodiments of the disclosure. The second method may be performed by a data management entity in a mobile communication network, such as the UDM/UDR 149, the UDM 240, the UDM/UDR 407, and/or the network apparatus 700, described above. The second method includes receiving a first message indicating that a UE registers with a second communication network and determining slice-based network selection information for the UE. The second method includes provisioning the UE with the slice-based network selection information (e.g., configuration information about the mapping between a network slice ID and network ID).

In some embodiments, the first message further indicates that the UE supports slice-based network selection (e.g., SoR-NS or mapping of network slice to network ID) and that the UE supports simultaneous registrations with multiple networks. In certain embodiments, the second method includes sending an indication to the UE that simultaneous registration with multiple networks is allowed and storing an indication that the UE is authorized for simultaneous registration with multiple networks. In some embodiments, the second method includes storing an indication that the UE has been successfully provisioned with the slice-based network selection information.

In some embodiments, the second method includes receiving a network configuration that a specific network slice is supported in a set of specific networks and storing the received network configuration. In some embodiments, determining the slice-based network selection information includes mapping each network slice to which the UE is subscribed to a specific network, where at least one network slice to which the UE is subscribed is not supported in the second network (e.g., but is supported in a third network).

In some embodiments, provisioning the UE with the slice-based network selection information includes performing a UE parameter update procedure and/or triggering a provisioning server (e.g., SoR-AF) to update a UE configuration of the UE with the slice-based network selection information.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A User Equipment (UE) for wireless communication, comprising:
at least one memory; and
at least one processor coupled with the at least one memory and configured to cause the UE to:
transmit a first message comprising an indication of a UE capability to support slice-based network selection;
receive a second message comprising slice-based network selection information;
store the received slice-based network selection information; and
perform slice-based network selection procedure based on to the received slice-based network selection information.

2. The UE of claim 1, wherein the first message comprises a Non-Access Stratum (NAS) Mobility Management (MM) message.

3. The UE of claim 1, wherein the at least one processor is configured to cause the UE to:
receive a capability request from a communication network; and
transmit the first message is in response to the capability request message.

4. The UE of claim 1, wherein the slice-based network selection information comprises a mapping of a network slice to a prioritized list of network identifiers.

5. The UE of claim 1, wherein the slice-based network selection information comprises a mapping of a network identifier to a network slice and associated priority.

6. The UE of claim 1, wherein to perform the slice-based network selection procedure according to the received slice-based network selection information, the at least one processor is configured to cause the UE to:
identify a set of-available networks;
determine whether at least one network of the set of available networks supports all subscribed network slices of the UE;
select a single network based at least in part on operator-controlled network selection information, in response to a determination that the at least one available network supports all the subscribed network slices;
select a network from the set of available networks that supports a set of preferred network slices of the UE based at least in part on slice-based network selection information, in response to a determination that no available network supports all the subscribed network slices; and
perform a registration procedure with the selected network.

7. The UE of claim 6, wherein the subscribed network slices of the UE corresponds to a list of all network slices from a UE route selection policy (URSP), wherein the set of preferred network slices of the UE comprises one or more network slices mapped to a preferred user service using the URSP, and wherein the preferred user service results from a connectivity request from an upper layer entity, a default service, or combinations thereof.

8. The UE method of claim 6, wherein the at least one processor is configured to cause the UE to derive the subscribed network slices of the UE is subscribed by performing one of:
identify a first set of Single-Network Slice Selection Assistance Information values (S-NSSAIs) for which there is mapping information in the slice-based network selection information;
identify a second set of S-NSSAIs for which there is a route selection descriptor in a set of UE Route Selection Policy (URSP) rules stored in the UE; and
identify a configured Network Slice Selection Assistance Information (NSSAI) for a Home Public Land Mobile Network (HPLMN) of the UE; and
derive the subscribed network slices of the UE based on the first set of S-NSSAIs, the second set of S-NSSAIs, and the configured NSSAI.

9. The UE of claim 1,
wherein the first message further indicates a UE capability to support simultaneous registrations with multiple networks, and
wherein the second message further comprises an indication that simultaneous registration with multiple networks is allowed.

10. A processor for wireless communication, comprising:
at least one controller coupled with at least one memory and configured to cause the processor to:
transmit a first message comprising an indication of a UE capability to support slice-based network selection; and
receive a second message comprising slice-based network selection information; and
store the received slice-based network selection information; and
perform slice-based network selection procedure based on the received slice-based network selection information.

11. A network entity comprising a user data management function (UDM), the network entity comprising:
at least one memory; and
at least one processor coupled with the at least one memory and configured to cause the UDM to:
receive a first message indicating that a User Equipment (UE) registers with a second communication network;
determine slice-based network selection information for the UE; and
provision the UE with the slice-based network selection information.

12. The network entity of claim 11, wherein the first message further indicates that the UE supports slice-based network selection and that the UE supports simultaneous registrations with multiple networks.

13. The network entity of claim 11, wherein the at least one processor is configured to cause the UDM to receive a network configuration that a specific network slice is supported in a set of specific networks.

14. The network entity of claim 11, wherein to determine the slice-based network selection information, the at least one processor is configured to cause the UDM to map each network slice to which the UE is subscribed to a specific network, wherein at least one network slice to which the UE is subscribed is not supported in the second network.

15. The network entity of claim 11, wherein to provision the UE with the slice-based network selection information, the at least one processor is configured to cause the UDM to:
perform a UE parameter update procedure; or trigger a provisioning server to update a UE configuration of the UE with the slice-based network selection information.

16. The UE of claim 6, wherein to perform the registration procedure, the at least one processor is configured to cause the UE to:
indicate an additional registration based on simultaneous registration with multiple networks being allowed, or
indicate an initial registration or a mobility registration, based on simultaneous registration with multiple networks not being allowed.

17. The UE of claim 9, wherein to perform the network selection procedure based on the received slice-based network selection information, the at least one processor is configured to:
select a plurality of networks; and
performing simultaneous registration with the selected plurality of networks,
wherein the selected plurality of networks collectively supports a preferred set of network slices.

18. The network entity of claim 11, wherein the at least one processor is configured to cause the UDM to store an indication that the UE has been successfully provisioned with the slice-based network selection information.

19. The network entity of claim 12, wherein the at least one processor is configured to cause the UDM to:
transmit an indication to the UE that simultaneous registration with multiple networks is allowed;
store an indication that the UE has been successfully provisioned with the slice-based network selection information; and
store an indication that the UE is authorized for simultaneous registration with multiple networks.

20. A method performed by a user data management function (UDM), the method comprising:
receiving a first message indicating that a User Equipment (UE) registers with a second communication network;
determining slice-based network selection information for the UE; and
provisioning the UE with the slice-based network selection information.
